(19) United States
(12) Patent Application Publication
(10) Pub. No.: US 2011/0278975 A1
(43) Pub. Date: Nov. 17, 2011

(54) DECREASED DRAG HIGH EFFICIENCY ELECTRIC GENERATOR

(75) Inventor: Robert Ray Holcomb, Nokomis, FL (US)

(73) Assignee: Redemptive Technologies Limited, Road Town Tortola (VG)

(21) Appl. No.: 13/143,780

(22) PCT Filed: Jan. 12, 2010
(86) PCT No.: PCT/IB2010/000043

§ 371 Date: Jul. 8, 2011

Related U.S. Application Data
(60) Provisional application No. 61/204,846, filed on Jan. 12, 2009.
(60) Provisional application No. 61/269,755, filed on Jun. 29, 2009.
(60) Provisional application No. 61/280,056, filed on Oct. 29, 2009.

(51) Int. Cl. H02K 47/14; H02K 16/02; H02K 53/00

(52) U.S. Cl. 310/113; 310/114; 74/DIG. 9

(57) ABSTRACT

A method, device and system is disclosed for decreased drag high efficiency electric generator by converting the vast majority of kinetic energy input into the electric generator, through the drive shaft, into usable electric power output by separating the destructive interactive forces between the stator magnetic poles and the rotor magnetic poles which allows, at full load, the release of approximately 80% additional electric energy, which in a conventional generator is dissipated by these interactions thereby reducing its potential efficiency by approximately 80%. More specifically, the classic armature and stator of conventional electric generators has been replaced by a stator having wire slots on the outer circumference of the stator exposing an induction coil winding of the stator. The rotor has a plurality of rotor members arranged in close proximity to the plurality of slots of the stator, where each rotor member has an armature mechanism forming magnetic poles that are activated and have magnetic polarities that are rotated relative to the plurality of slots, and the rotor coupled to a driver shaft for rotating and for generating an electric current. Shielding is provided to decrease drag and improve efficiency.

### FIELD OF THE INVENTION

This invention relates generally to a decreased drag high efficiency electric generator, and more particularly to a method and apparatus for the use of kinetic energy for the conversion of energy from electrons in the environment to electrical energy in the form of either alternating current (AC) or direct current (DC) with reduced electromagnetic drag within the generator machine which makes this conversion.

### BACKGROUND

This earth upon which we live has existed for an unknown number of years. It is safe to say that man has resided upon the earth for thousands to millions of years. Only over the past four hundred years has man begun to destroy the very earth upon which he lives and depends for all of his life support. We are using very large amounts of exhaustible energy from the earth, largely in the form of fossil fuels. We are rapidly depleting our energy resources, polluting the environment and increasing global warming. We need an alternative energy supply and we need to generate and use current energy supplies more efficiently.

The need for power generation units which do not destroy the equilibrium of the earth for an infinite period of time is obvious. If one looks at all of the renewable sources available, each one has significant problems of availability, reliability and expense. Such resources are solar, wind, hydroelectric, electrostatic, temperature differential and geothermal. If it could be harnessed, gravity is the most attractive.

In existing traditional electric power generators, our understanding of the electrical generating process is based on the concept that kinetic energy input is transformed into electrical energy by producing a changing or moving magnetic field. During the motor reaction in a generator, when a generator supplies current to a load, the load current creates a back electromotive force that opposes the rotation of the generator armature. If the current in the conductor increases, the reaction force on drag increases. More force must be applied to the armature as the load increases to overcome destructive interactive forces to keep the armature from slowing.

Therefore, there is a need for increasing efficiency and decreasing drag in an electric power generation to address or at least alleviate the limitations and improve the overall efficiency of conventional electric power generators.

### SUMMARY

In accordance with embodiments of the invention a method, a device and system is disclosed for converting the vast majority of kinetic energy input into an electric generator, through the drive shaft, into usable electric power output by separating the destructive interactive forces between the stator magnetic poles and the rotor magnetic poles which allows, at full load, the release of approximately 80% additional electric energy, which in a conventional generator is dissipated by these interactions thereby reducing its potential efficiency by approximately 80%.

An aspect of the invention is an electric generator comprising a stator having a plurality of slots formed along the external surface of the stator, each slot exposing an induction coil winding of the stator; and a rotor having a plurality of rotor members arranged in close proximity to the plurality of slots of the stator, each rotor member having an armature mechanism forming magnetic poles that are activated and have magnetic polarities that are rotated relative to the plurality of slots, and the rotor coupled to a driver shaft for rotating and for generating an electric current.

An aspect of the invention is a method for generating electricity in an electric generator comprises arranging a stator having a plurality of slots formed along the external surface of the stator, each slot exposing an induction coil winding of the stator; and positioning a rotor having a plurality of rotor members arranged in close proximity to the plurality of slots of the stator, each rotor member having an armature mechanism forming magnetic poles that are activated and have magnetic polarities that are rotated relative to the plurality of slots, and the rotor coupled to a driver shaft for rotating and for generating an electric current.

In accordance with an embodiment, the rotor and/or armature of the classical generator is replaced by a rotor having a plurality of rotor members with armature assemblies. The rotor members spin in a designated sequence over each stator wire slot, thereby reducing the interaction with the polar forces of the stator and the rotor. The rotor members each are shielded and comprise a magnetic shield, such as tubular in form or the like, made of a shielding material that is constructed of or applied to the surface of the rotor members such as laminated mu metal and steel around each slot rotor with only an open slot over the width of each wire slot, thereby further reducing the interaction between the magnetic poles of the stator and the rotor. The shield of the rotor prevents interaction between the stator magnetic fields and the rotor magnetic fields except for interactions occurring at the opening of the rotor member between the opening of the rotor members and the slots of the stator. The small individual slot magnetic rotors are configured into a support bearing on each of the ends of the shaft, the support bearings being contained in a support means which holds the rotors in close proximity to the slots.

In accordance with an embodiment, in assembly of the stator, laminated sheets of very thin steel are applied onto/into a circular stator with wire slots located along the surface or around the circumference of the stator. It will be appreciated that the number of slots stator may vary depending on application, however, in one embodiment there are 48 wire slots on the inner radius and/or outer radius of the laminated steel stator. The stator is supported by a support means and the stator is configured with winding of induction into the insulated wire slots of the stator. The induction coils in the stator are connected in the proper sequence and pattern to allow the generation of 3-phase, single phase or 2-phase power but not limited to 3-phase, single phase or 2-phase alternating current. The stator comprises a material to shield from and is shielded from the plurality of rotor members except for the wire slots. To the surface of the stator a shield is applied such as a mu metal laminated with thin carbon steel, or the like, is attached to the flat surface of the stator tooth between each wire slot as one of the components of separating the magnetic poles within the stator from the magnetic poles of the rotor, thereby removing the electromagnetic drag forces. The shield of the stator prevents interaction between the stator magnetic fields and the rotor magnetic fields except for interactions occurring at the slots of the stator between the slots of the stator and the openings of the rotor members.

In accordance with an embodiment, the slot rotors are sequenced such that the magnetic poles separated by neutral nonmagnetic zones circulate around the stator wire slots in the same manner as a rotor of a classic generator without a mechanical rotor spinning inside or outside the stator. Each slot rotor is separated and has orientation of one slot rotor to the next by 15° for a two pole rotor and 7.5° for a four pole rotor. The sequencing of the rotor magnetic poles are arranged such that for a 3-phase 48 slot 4-pole AC motor in a 360° pattern 8 slots are covered by a north pole magnetic flux, followed by 4 slots with no flux, followed by 8 slots covered by a south pole magnetic flux, followed by 4 slots with no flux, followed by 8 slots covered by north pole magnetic flux, followed by 4 slots with no magnetic flux, followed by 8 slots covered by south pole magnetic flux, followed by 4 slots with no magnetic flux. In driving the transmission may be arranged with an electric 3-phase drive motor driven by a square wave variable speed controller which is powered through the DC batteries which are recharged through rectifiers through the high efficiency generator output and/or the power grid.

In an embodiment, the electric generator is configured to drive the sequenced rotors through a shaft which connects to a master transmission which is driven by a drive source such as a motor or turbine. The slot rotor may be comprised of static magnetic power or electromagnetic power with electromagnetic rotors being preferred because they may be turned on and off at will. The electric generator may be configured to powering the 2-pole or 4-pole rotor with brushes and slip rings which are sequenced such that only the magnetic pole passing directly over the wire slot is excited and it is turned off as it passes off the slot such that there is no unfavorable interaction between the slot rotors.

The sequencing the slot rotors may be controlled by a controller such as for example by a solid state mechanism, a master communitator mechanism, or the like, to turn the poles on and off to attain the desired effect. The rotors may be powered through DC batteries which, are charged through rectifiers from the generator output and power grid.

What is provided is a process whereby electric power generation may be accomplished without significant electromagnetic drag within the generator. Removal of the electromagnetic drag between the stator and armature could allow a 4-fold or greater increase in electrical energy output with the same mechanical or kinetic energy input. What is provided is a mechanical input of, for instance, a one horsepower electric motor driving an electric generator of the invention. One horsepower mechanical energy, rather than generating 746 watts, may generate approximately 3,000 watts or more. Therefore the classic electric motor when driving the generator of the invention will consume 746 watts of electric energy and generate 3,000 watts, thereby generating an additional 2,254 watts of usable energy. Also revealed in this application is three embodiments of the invention. The first embodiment reveals a three-phase 50 cycle or 60 cycle generator with the wire slots on the outer radius of the stator. In this embodiment of the invention, the rotating magnets may be either bipolar or quadripolar. If the stator contains 48 slots with three-phase four pole winding and bipolar magnets are used as the exciting rotating member, these magnets will spin in sequence 15° retarded from the adjacent previous pole orientation. If the stator contains 48 slots and a four pole three-phase winding, the four pole rotating magnets spin in a sequence 7.5° retarded from the adjacent previous four pole rotating magnet member. In the case of quadripolar, two sections of the rotating magnets are north-pole charged, and two sections are south-pole charged. The magnetized face of the electromagnets alternate north-pole, south-pole, north-pole, south-pole, etc. with non-magnetized segments between each pole. The magnetized segments comprise twice the percentage of the total circumference of the face of the rotating magnetic poles as compared to the non-magnetized segments. This spatial arrangement allows 50 cycle or 50 Hz of current to be generated when the magnets are rotated at 1500 rpm's and 60 cycle or 60 Hz current to be generated when the magnets are rotated at 1800 rpm's. In the case of north-south pole bipolar magnetic rotors 50 cycle or 50 Hz current would be generated when the bodies are rotated at 3,000 rpm's and 60 cycle or 60 Hz would be generated when the magnets are rotated at 3600 rpm's. The spinning magnetic rotors are contained in a cylindrical cavity placed in close proximity to the stator wire slots. The shielded cavity contains a slot which is approximately 60% wider than the opening of the wire slot but is centered over the wire slot and is as long as the wire slot. This allows the magnetic flux to penetrate the wire slot but protects the spinning magnetic rotor from interaction with the electromagnetic drag forces of the stator. The stator of this embodiment is constructed with the wire slots on the outer surface of the circular laminated steel stator rather than on the inner surface as is the case in a standard electric power generator. There are 48 slots but not limited to 48 slots on the outer surface. The generator is preferably wound with a three-phase winding containing twelve coils i.e. three phase groups and four coils per group and is wound in a “lap” three-phase winding pattern. The center cavity of the stator contains an attached circular member which supports a riser with a circular support means to which the 48 quadripolar or bipolar magnetic rotors of the armature mechanism are attached. This new armature mechanism is supported on either end by bearings in a bearing block with commentator mechanism on the shaft of one end and a shaft on the other end which attaches via a coupling to the driver shaft of the transmission. The magnets are sequenced and timed within the transmission. As the magnets are spun by the gear mechanism of the transmission in sequence the effect is the same as a large spinning magnetized armature (as is used in current technology) except that the drag is mostly removed by shielding and by the fact that the small armatures spin within the stator field and do not move through the magnetic flux lines of the stator poles. In order for the generator to generate power at maximum efficiency, there must be a neutral or magnetically dead zone between each of the four poles of the generator. Of the 48 slots in the stator, each magnetic pole covers at any point in time eight slots (eight slots—south pole, eight slots—north pole, eight slots—south pole, eight slots—north pole). The other 16 slots are covered by magnetically neutralized or dead magnetic rotors (four dead zone wire slots are between each magnetic pole). The dead zone between magnetic poles is accomplished by a master commentator mechanism which feeds the small commentator or slip ring on the end of each spinning magnet. Due to the mu metal shielding, the north poles and south poles only see a narrow segment of the opposing stator magnetic poles (magnetic poles are defined as organized magnetic flux densities either north-pole or south-pole oriented) which comes through the wire in the wire slots. The opposing stator poles permeate the wire slots very poorly. The north-pole and south-pole magnets spin in a sequence 7.5° retarded from the adjacent previous pole, therefore if one looks at a static view one sees 8 slots north-pole, followed by 4 slots with no power and therefore no magnetic field, etc. yielding a total of two north-poles, two south-poles, and four neutral zones. This sequence yields the identical same four rotating magnetic poles and neutral areas in the same placement balance and effect as a standard generator armature. However this arrangement allows less than 10% of the drag to occur which one finds present in a standard electric power generator. This would allow 12,000 watts of energy to drive a motor that would pull a generator which would put out at least 80,000 watts of net power.

This arrangement does not allow significant magnetic interaction between the stator and the armature. Any interaction which exists and therefore any drag will decrease as the load begins to flow such that current flow increases in the wire slots of the stator.

It is the principle object of an embodiment of the present invention to provide a method which will greatly decrease the electromagnetic interaction between the rotor and the stator of an electric generator and thereby decrease the electromagnetic drag to allow the production of electric power at greater efficiency.

It is a further object of an embodiment of the present invention to provide a small, elongated DC powered two-pole or four-pole electromagnetic armature which is only activated as the desired pole rotates over a single wire slot of the stator of the electric power generator of the invention.

The second embodiment of the invention is revealed in which a series of bipolar permanent magnetic bodies is enclosed in a shielded cylinder. The small cylinder housed in a larger cylinder insert which is pressed into the stator of the generator such that only the area over the wire slot is exposed to the magnetic field of the spinning bipolar permanent magnetic bodies. These magnetic bodies extend the length of the wire slot. These bodies are rotated by a gear mechanism which is rotated by a center shaft through the end bells of the generator and attaches to the mechanical drive system. This arrangement again does not allow significant magnetic interaction between the stator and the armature. Any interaction which exists and therefore any drag will decrease as a load is applied to the generator such that current flow increases in the wire slots.

It is a principle object of this second embodiment of the invention to provide a method by which a standard electric generator may be retrofitted to greatly decrease the electromagnetic drag and produce electric power at a greater efficiency:

It is a further object of an embodiment of this invention to reveal the various components of the newly designed high efficiency generator. The neutral zones described in the first embodiment of the invention are also important in this embodiment and may be accomplished by rotating shield if one desires to maximize power output;

### BRIEF DESCRIPTION OF THE DRAWINGS

In order that embodiments of the invention may be fully and more clearly understood by way of non-limitative examples, the following description is taken in conjunction with the accompanying drawings in which like reference numerals designate similar or corresponding elements, regions and portions, and in which:

FIG. 1 is an illustration of the stator of an embodiment of the invention with a depiction of the 48 4 pole armature inserts sequenced 7.5° apart such that a quadrapole magnetic field is generated around the 360° of the stator in accordance with an embodiment of the invention;

FIG. 2 is an illustration of the stator of an embodiment of the invention with a depiction of the 48 4 pole armature inserts advanced 7.5° in a clockwise direction with respect of FIG. 1;

FIG. 3 is an illustration of the stator of an embodiment of the invention with a depiction of the 48 4 pole armature inserts advanced 7.5° in a clockwise direction with respect to FIG. 2;

FIG. 4 is an illustration of the stator of an embodiment of the invention with a depiction of the 48 4 pole armature inserts advanced 7.5° in a clockwise direction with respect to FIG. 3;

FIG. 5 is an illustration of the stator of an embodiment of the invention with a depiction of the 48 4 pole armature inserts advanced 7.5° in a clockwise direction with respect to FIG. 4;

FIG. 6 is an illustration of the stator of an embodiment of the invention with a depiction of the 48 4 pole armature inserts advanced 7.5° in a clockwise direction with respect to FIG. 5;

FIG. 7 is an illustration of the stator of an embodiment of the invention with a depiction of the 48 4 pole armature inserts advanced 7.5° in a clockwise direction with respect to FIG. 6;

FIG. 8 is an illustration of the stator of an embodiment of the invention with a depiction of the 48 4 pole armature inserts advanced 7.5° in a clockwise direction with respect to FIG. 7;

FIG. 9 is an illustration of the stator of an embodiment of the invention with a depiction of the 48 4 pole armature inserts advanced 7.5° in a clockwise direction with respect to FIG. 8;

FIG. 10 is an illustration of the stator of an embodiment of the invention with a depiction of the 48 4 pole armature inserts advanced 7.5° in a clockwise direction with respect to FIG. 9;

FIG. 11 is an illustration of the stator of an embodiment of the invention with a depiction of the 48 4 pole armature inserts advanced 7.5° in a clockwise direction with respect to FIG. 10;

FIG. 12 is an illustration of the stator of an embodiment of the invention with a depiction of the 48 4 pole armature inserts advanced 7.5° in a clockwise direction with respect to FIG. 11;

FIG. 13 is an illustration of the stator of an embodiment of the invention with a depiction of the 48 4 pole armature inserts advanced 7.5° in a clockwise direction with respect to FIG. 12;

FIG. 14 is an illustration of the stator of an embodiment of the invention with a depiction of the 48 4 pole armature inserts advanced 7.5° in a clockwise direction with respect to FIG. 13;

FIG. 15 is an illustration of the stator of an embodiment of the invention with a depiction of the 48 4 pole armature inserts advanced 7.5° in a clockwise direction with respect to FIG. 14;

FIG. 16 is an illustration of the stator of an embodiment of the invention with a depiction of the 48 4 pole armature inserts advanced 7.5° in a clockwise direction with respect to FIG. 15;

FIG. 17 is an illustration of the stator of an embodiment of the invention with a depiction of the 48 4 pole armature inserts advanced 7.5° in a clockwise direction with respect to FIG. 16;

FIG. 18 is an illustration of the stator of an embodiment of the invention with a depiction of the 48 4 pole armature inserts advanced 7.5° in a clockwise direction with respect to FIG. 17;

FIG. 19 is an illustration of the stator of an embodiment of the invention with a depiction of the 48 4 pole armature inserts advanced 7.5° in a clockwise direction with respect to FIG. 18;

FIG. 20 is an illustration of the stator of an embodiment of the invention with a depiction of the 48 4 pole armature inserts advanced 7.5° in a clockwise direction with respect to FIG. 19;

FIG. 21 is an illustration of the stator of an embodiment of the invention with a depiction of the 48 4 pole armature inserts advanced 7.5° in a clockwise direction with respect to FIG. 20;

FIG. 22 is an illustration of the stator of an embodiment of the invention with a depiction of the 48 4 pole armature inserts advanced 7.5° in a clockwise direction with respect to FIG. 21;

FIG. 23 is an illustration of the stator of an embodiment of the invention with a depiction of the 48 4 pole armature inserts advanced 7.5° in a clockwise direction with respect to FIG. 22;

FIG. 24 is an illustration of the stator of an embodiment of the invention with a depiction of the 48 4 pole armature inserts advanced 7.5° in a clockwise direction with respect to FIG. 23;

FIG. 25 is an illustration of the stator of an embodiment of the invention with a depiction of the 48 4 pole armature inserts advanced 7.5° in a clockwise direction with respect to FIG. 24;

FIG. 26 is an illustration of the stator of an embodiment of the invention with a depiction of the 48 4 pole armature inserts advanced 7.5° in a clockwise direction with respect to FIG. 25;

FIG. 27 is an illustration of the stator of an embodiment of the invention with a depiction of the 48 4 pole armature inserts advanced 7.5° in a clockwise direction with respect to FIG. 26;

FIG. 28 is an illustration of the stator of an embodiment of the invention with a depiction of the 48 4 pole armature inserts advanced 7.5° in a clockwise direction with respect to FIG. 27;

FIG. 29 is an illustration of the stator of an embodiment of the invention with a depiction of the 48 4 pole armature inserts advanced 7.5° in a clockwise direction with respect to FIG. 28;

FIG. 30 is an illustration of the stator of an embodiment of the invention with a depiction of the 48 4 pole armature inserts advanced 7.5° in a clockwise direction with respect to FIG. 29;

FIG. 31 is an illustration of the stator of an embodiment of the invention with a depiction of the 48 4 pole armature inserts advanced 7.5° in a clockwise direction with respect to FIG. 30;

FIG. 32 is an illustration of the stator of an embodiment of the invention with a depiction of the 48 4 pole armature inserts advanced 7.5° in a clockwise direction with respect to FIG. 31;

FIG. 33 is an illustration of the stator of an embodiment of the invention with a depiction of the 48 4 pole armature inserts advanced 7.5° in a clockwise direction with respect to FIG. 32;

FIG. 34 is an illustration of the stator of an embodiment of the invention with a depiction of the 48 4 pole armature inserts advanced 7.5° in a clockwise direction with respect to FIG. 33;

FIG. 35 is an illustration of the stator of an embodiment of the invention with a depiction of the 48 4 pole armature inserts advanced 7.5° in a clockwise direction with respect to FIG. 34;

FIG. 36 is an illustration of the stator of an embodiment of the invention with a depiction of the 48 4 pole armature inserts advanced 7.5° in a clockwise direction with respect to FIG. 35;

FIG. 37 is an illustration of the stator of an embodiment of the invention with a depiction of the 48 4 pole armature inserts advanced 7.5° in a clockwise direction with respect to FIG. 36;

FIG. 38 is an illustration of the stator of an embodiment of the invention with a depiction of the 48 4 pole armature inserts advanced 7.5° in a clockwise direction with respect to FIG. 37;

FIG. 39 is an illustration of the stator of an embodiment of the invention with a depiction of the 48 4 pole armature inserts advanced 7.5° in a clockwise direction with respect to FIG. 38;

FIG. 40 is an illustration of the stator of an embodiment of the invention with a depiction of the 48 4 pole armature inserts advanced 7.5° in a clockwise direction with respect to FIG. 39;

FIG. 41 is an illustration of the stator of an embodiment of the invention with a depiction of the 48 4 pole armature inserts advanced 7.5° in a clockwise direction with respect to FIG. 40;

FIG. 42 is an illustration of the stator of an embodiment of the invention with a depiction of the 48 4 pole armature inserts advanced 7.5° in a clockwise direction with respect to FIG. 41;

FIG. 43 is an illustration of the stator of an embodiment of the invention with a depiction of the 48 4 pole armature inserts advanced 7.5° in a clockwise direction with respect to FIG. 42;

FIG. 44 is an illustration of the stator of an embodiment of the invention with a depiction of the 48 4 pole armature inserts advanced 7.5° in a clockwise direction with respect to FIG. 43;

FIG. 45 is an illustration of the stator of an embodiment of the invention with a depiction of the 48 4 pole armature inserts advanced 7.5° in a clockwise direction with respect to FIG. 44;

FIG. 46 is an illustration of the stator of an embodiment of the invention with a depiction of the 48 4 pole armature inserts advanced 7.5° in a clockwise direction with respect to FIG. 45;

FIG. 47 is an illustration of the stator of an embodiment of the invention with a depiction of the 48 4 pole armature inserts advanced 7.5° in a clockwise direction with respect to FIG. 46;

FIG. 48 is an illustration of the stator of an embodiment of the invention with a depiction of the 48 4 pole armature inserts advanced 7.5° in a clockwise direction with respect to FIG. 47;

FIG. 49 is an illustration of an electromagnetic slot pole of the invention illustrating the pole winding and mu metal shielding in accordance with an embodiment of the invention;

FIG. 50 is an illustration of a superior lateral projection of an electromagnetic slot pole of an embodiment of the invention;

FIG. 51 is an illustration of a superior lateral projection of the mu metal stainless steel shield sleeve containment means and magnetic shielding means for the slot pole containment means in accordance with an embodiment of the invention.

FIG. 52 is an illustration of a schematic view of the embodiment of the invention as it would interact with the power grid.

FIG. 53 is an illustration of the stator of an embodiment of the invention which contains the armature insert without depiction of the housing or end bells;

FIG. 54 is an illustration of the non-ferromagnetic cylinder insert portion of the armature insert which contains the magnetic poles of the armature mechanism in accordance with an embodiment of the invention;

FIG. 55 is an illustration of a magnetic pole contained within the Mu Metal laminated sleeve which is contained in the non-ferromagnetic cylinder insert portion of the armature mechanism in accordance with an embodiment of the invention;

FIG. 56 is an illustration of the non-ferromagnetic containment means for the magnetic poles of the armature mechanism of the invention along with the bearings and gear mechanism in accordance with an embodiment of the invention;

FIG. 57 is an illustration of a superior lateral projection of the Mu Metal stainless steel shield sleeve containment means and magnetic shielding means for the pole containment means of FIG. 56;

FIG. 58 is an illustration of a lateral oblique view of the end bells of the invention along with the gear drive mechanism of the armature in accordance with an embodiment of the invention;

FIG. 59 is an illustration of a lateral oblique projection of the stator of an embodiment of the invention;

FIG. 60 is an illustration of the synchronous rotation of the north pole over the superior coil slots through a 180° rotation in accordance with an embodiment of the invention;

FIG. 61 is an illustration of the synchronous rotation of the south pole over the inferior coil slots through a 180° rotation in accordance with an embodiment of the invention;

FIG. 62 is an illustration of the use of the invention to magnify power from the grid and place the newly generated power back onto the electric power grid in accordance with an embodiment of the invention;

FIG. 63 is an illustration of a three phase four pole clockwise lap winding of the invention;

FIG. 64 is an illustration of a three phase four pole counter-clockwise lap winding of an embodiment of the invention;

FIG. 65 is an illustration of the 48 slot three phase four pole lap wound generator demonstrating the 48 bi-pole rotors sequenced 15° advanced one to the other for the complete 360° circumference of the stator, producing four rotating magnetic poles covering eight slots and separated by four neutral zones each covering four slots in accordance with an embodiment of the invention;

FIG. 66 is an illustration of the diagrammatic representation of the internal hookup of a three phase four pole “high-wye” winding of an embodiment of the invention;

FIG. 67A-B is an illustration of an electromagnetic slot pole of an embodiment of the invention illustrating the pole winding, cog wheel drive and mu metal shielding in accordance with an embodiment of the invention; and

FIG. 68 is an illustration of a superior lateral projection of an electromagnetic slot pole of an embodiment of the invention.

### DETAILED DESCRIPTION

The method and apparatus of embodiments of the present invention relates to the use of kinetic energy for the conversion of energy from electrons in the environment to electrical energy in the form of either alternating current (AC) or direct current (DC) with reduced electromagnetic drag within the generator machine which makes this conversion, and therefore with greatly improved efficiency.

Embodiments of the invention reveal a method for increasing the electrical output from mechanical energy input. Typically an ordinary electric generator will convert close to 99% of supplied mechanical power into electric power. However, that is based on a technology-influenced formula of one horsepower used to generate 746 watts of electricity at 100% efficiency, based on current generator design. Scientists believe that superconducting coils could probably be more efficient. A superconducting generator can be 10-times smaller than a conventional generator. If one removes the reaction force or magnetic drag from the armature of an AC or DC generator, the efficiency could increase by 400-500%. Therefore one horsepower could generate up to 3,730 watts. By combining superconductivity and removal of power drag, it is estimated that a greater than 10-fold increase in efficiency could be the result.

Every atom has a nucleus composed of positively charged protons and uncharged neutrons. Negatively charged electrons orbit the nucleus. In most atoms, the number of electrons is equal to the number of protons in the nucleus, so that there is no net charge. If the number of electrons is less than the number of protons, then the atom has a net positive charge. If the number of electrons is greater than the number of protons, then the atom has a net negative charge. Within the universe, there is electrical neutrality, however there are local concentrations of charge throughout biological and physical systems. These local concentrations are responsible for all electrical activity. In the universe not all electrons are involved in the structure of material; there are vast numbers of electrons which are loosely bound “electrons at large.” These “electrons at large” are in equilibrium with outer shell electrons of atoms in the environment. It is from this pool of electrons that electric current is generated. These electrons are in the atmosphere and in the ground. Electrons in motion constitute an electric current. Thus if electrical pressure from a generator is applied to an electrical conductor, such as copper wire, and the circuit closed, electrons will flow along the wire from negative to positive and ultimately to ground. These electrons pass from atom to atom and we have electric current. The electrons which move rather freely are loosely bound electrons or electrons “at large.” They may be compared to dominoes set on end. If the first one is pushed over, it knocks the next one over and so on. This progression of movement of energy occurs at the speed of light, or approximately 186,000 miles per second. A wire connected to a DC power source will cause electrons to flow through the wire in a manner similar to the way water flows through a pipe. This means that the path of any one electron essentially can be anywhere within the volume of the wire (i.e. center, middle, radius or surface). When an AC voltage is applied across a wire it will cause electrons to vibrate back and forth. In this vibrating process, the electrons will generate magnetic fields. The magnetic fields push electrons toward the surface of the wire. As the frequency of the applied signal increases, the electrons are pushed farther away from the center and toward the surface.

The existing traditional electric power generator is based upon our understanding that kinetic energy input is transformed into electrical energy by producing a changing or moving magnetic field. This is a superficial concept. If we analyze the process of electric power generation, we find that the kinetic energy input moves a magnetic field. This changing magnetic field moving across the conductor wires in the wire slots of the stator of the electric generator causes an electrical current to flow in the coils of the generator stator. The electrical current flowing in the coils of the stator creates a magnetic field by virtue of the physical construction of the coils and the laminated steel in which they are wound. This newly created magnetic field increases in strength as electric power is increasingly drawn from the generator and is approximately equal and of opposite polarity to the original source of the magnetic field, i.e. the rotor or armature. This stator field interacts with the original source of the magnetic field which ends up dissipating the kinetic energy input to the system.

Therefore, it may appear that kinetic energy is being converted into electrical energy. But in fact the kinetic energy is only eliciting electrical energy, which by virtue of design of the generator, is dissipating the kinetic energy input by acting in the opposite direction to the original magnetic excitation energy. It is a problem of generator design rather than a necessity of the generator process. A change in generator design can eliminate the unwanted byproduct of the back electromotive force which manifests itself in the form of drag due to the secondary magnetomotive (mmf) force without effecting the generating process. The input of kinetic energy is no longer related to electrical output. The present invention addresses and deals with these issues. More particularly, the present invention relates to various embodiments of an electrical generator system in which the magnetically polarized rotor is replaced by a series of shielded (for example, mu metal—annealed 75% nickel, 15% iron, plus copper and molybdenum, or the like) magnetic poles affixed over and in close proximity to each wire slot in the stator with each magnetic body being constructed as small, permanent magnetic armatures or wound inductive magnetic armatures. The unique design of the preferred design is powered by a DC current supply which activates pole coils through a brush and slip ring or commentator mechanism such that the magnetic poles are only activated as they are rotated over the unshielded wire slot. The small armature mechanism is separated from the back mmf by mu metal shields placed on the tooth surface of the stator which shields interaction between the stator magnetic fields and the rotor magnetic fields except for an open slot over the wire slots of the stator. In addition, mu metal shield cylinders completely surround the small armature mechanisms. These cylinders are only open to the wire slots of the stator. The shielded magnetic or electromagnetic poles are rotated by a transmission mechanism which effectively exposes the wire slots to a moving magnetic field over the slots of the stator induction coils. In the case of the shielded electromagnetic poles, they are rotated by a transmission mechanism which effectively exposes the wire slots of the stator to a moving magnetic field over the slots of the induction coils. The magnetic poles of the armature mechanism are only activated as they rotate over the wire slots. Depending upon the pole activation sequence, either alternating current (AC) or direct current (DC) can be generated. The attributes of the current invention allows generators of practically unlimited size with greatly improved efficiency to be constructed. The efficiency increase, when compared to a present day electric generation technology, is significant.

Generally, in motor reaction in a generator, when a generator supplies current to a load, the load current creates a force that opposes the rotation of the generator armature. If the current in the conductor increases, the reaction force on drag increases. More force must be applied to the armature as the load increases to keep it from slowing. In embodiments of the invention, the motor reaction force may be reduced by rotating bipolar or quadrapolar magnets on their axis shielded by a magnetic shield over each wire slot of the generator. The magnet contained within a shielded Mu Metal, stainless steel laminated cylinder is the same length as the slot and in the present invention the magnetic fields are generated by poles which are wound by copper magnet wire and activated by DC current and the laminated steel of the stator is shielded between the slots with Mu metal shielding.

### Embodiment I

### Decreased Drag Electric Three-Phase Power Generator

The structure and mechanism of this embodiment of the present invention will allow electric energy to be generated by currently available fossil fuel driven energy sources with greatly increased efficiency, therefore less fossil fuels will be consumed and therefore less production of greenhouse gases will result.

The enhanced efficiency is obtained due to the removal of electromagnetic drag from the system. The classic armature and stator has been replaced by a laminated steel stator in which the wire slots are on the outer circumference and the “back iron” is on the inner circumference. A support means is also attached to the inner circumference which supports the stator such that the plane of the end portions of the stator are parallel with the base of the support means. Attached to the base support means is also attached the armature bearing blocks and support means. This armature support means supports the 48 four pole armature mechanisms in proper proximity to the stator slots in order to deliver the proper magnetic flux to the wire slots. The 48 armature mechanisms are contained in mu metal (magnetic shielding material) cylinders with an appropriate open slot in the shield directly over the stator wire slot. The 4 polar electromagnetic bar assembly is rotated to provide alternating north and south pole energy into the open wire slots of the induction coils in the stator. The magnetic poles are activated with DC current via a brush and slip ring apparatus or other aggregeriate solid state mechanism such that the magnetic pole is activated only as it passes over the wire slot. The mu metal laminated shield is only open precisely over the wire slot. The armature mechanisms are spinning on their axis in only a small portion of the magnetic poles of the stator. These features allow only minimal electromagnetic drag upon the spinning 4 polar electromagnetic armature.

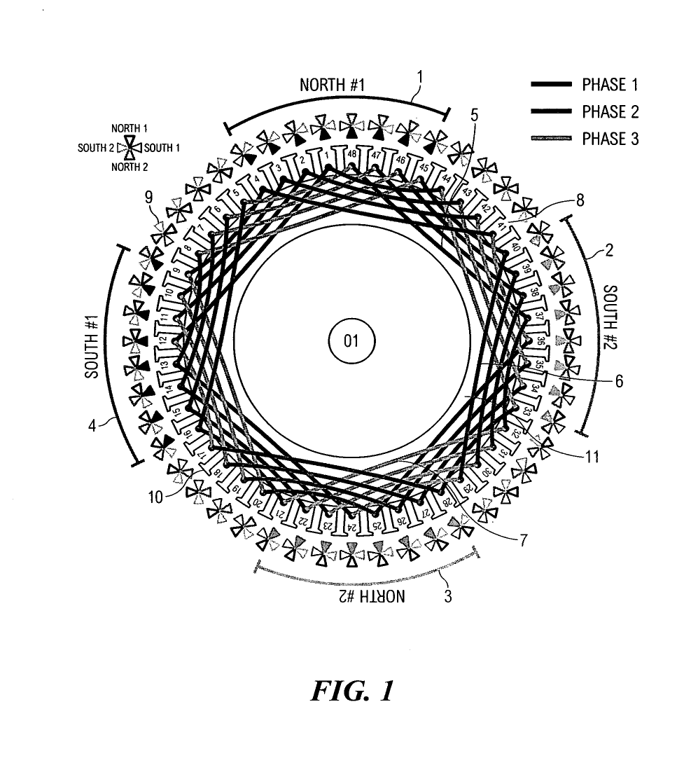

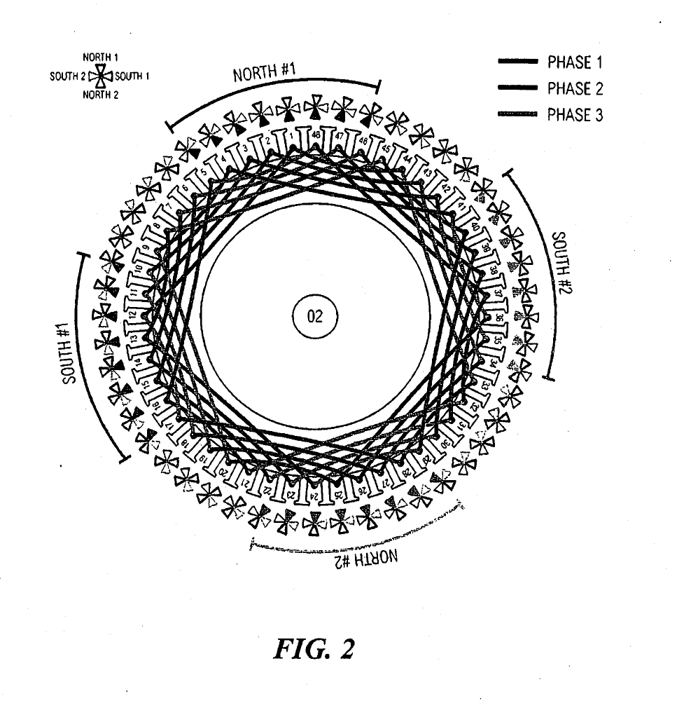

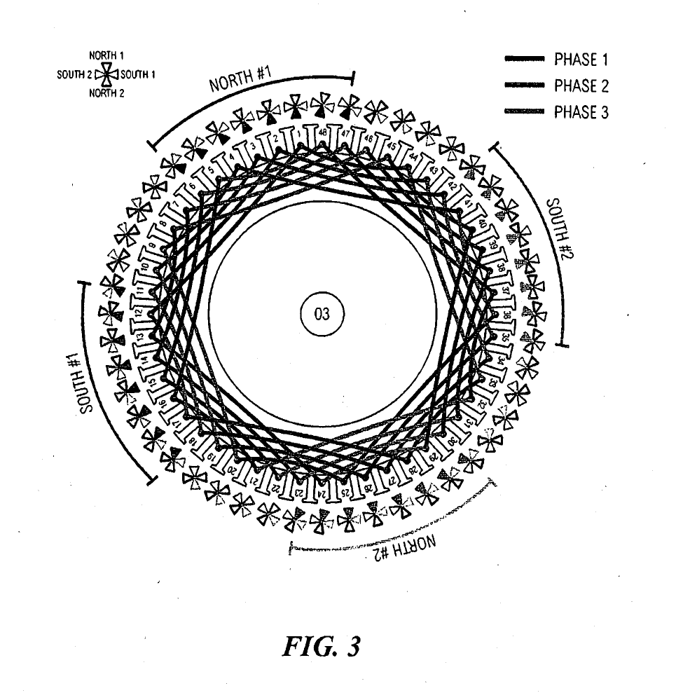

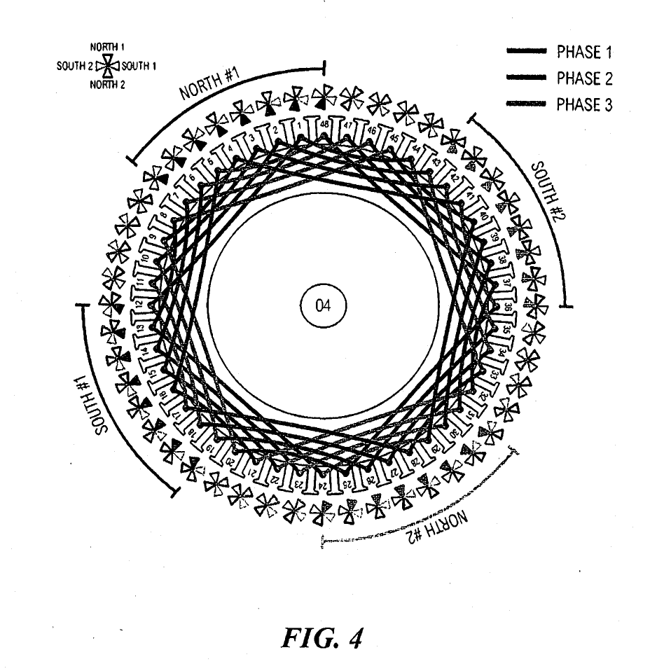

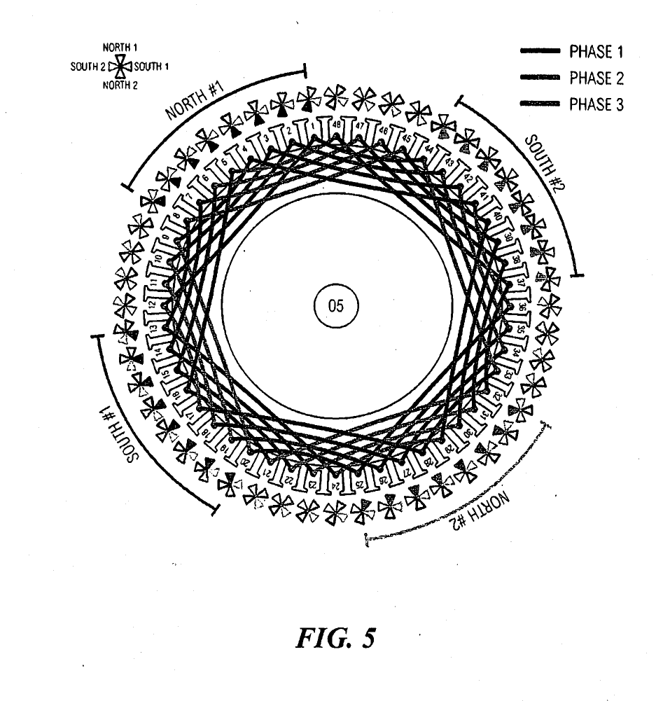

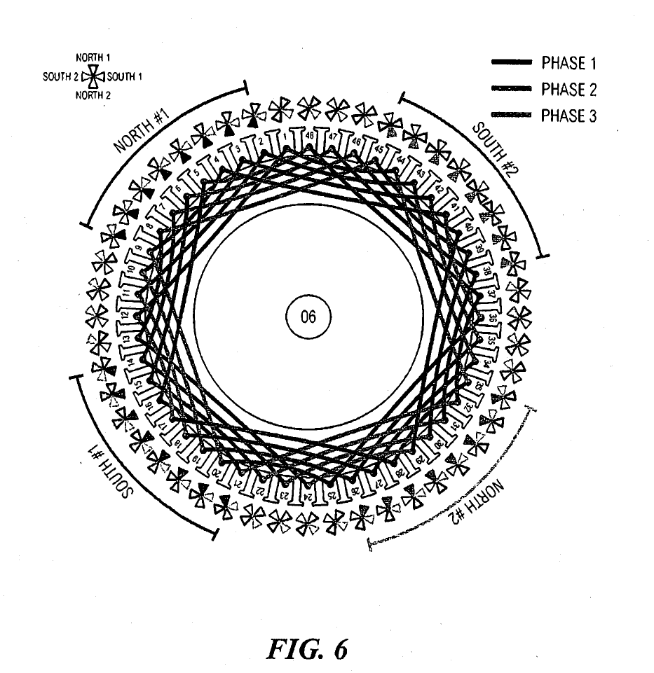

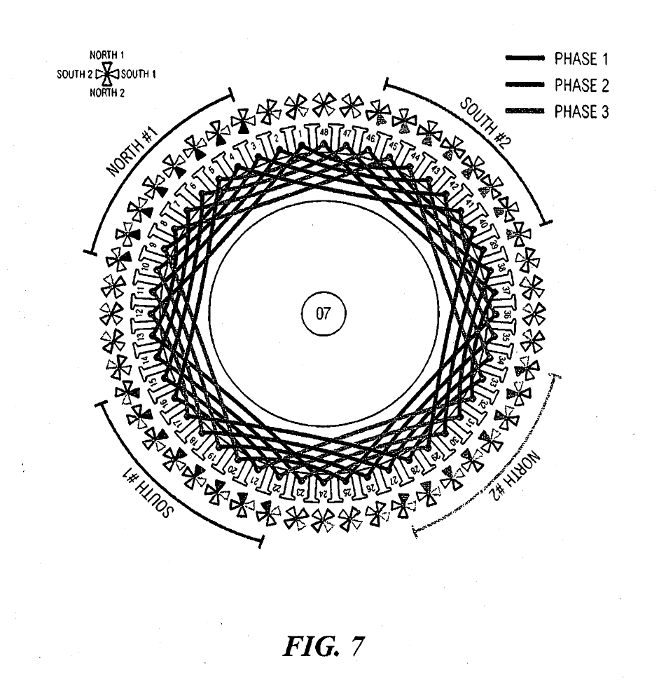

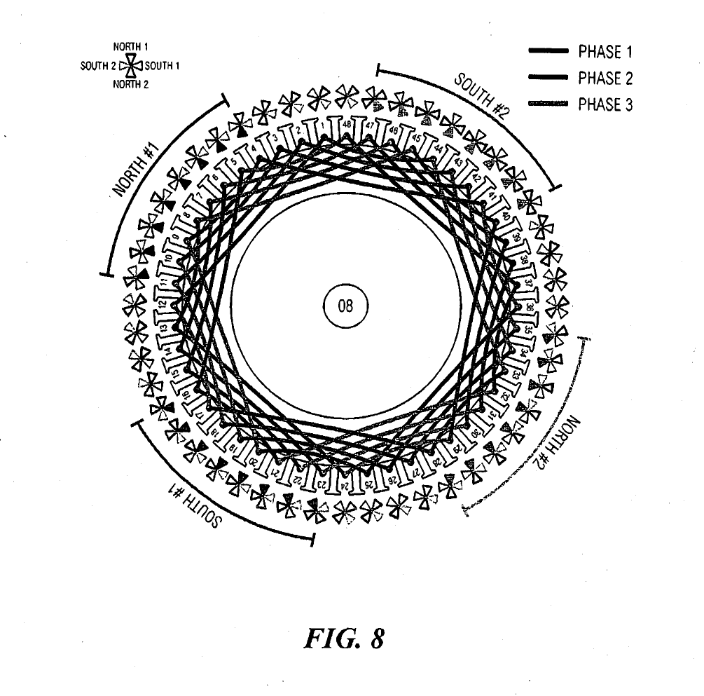

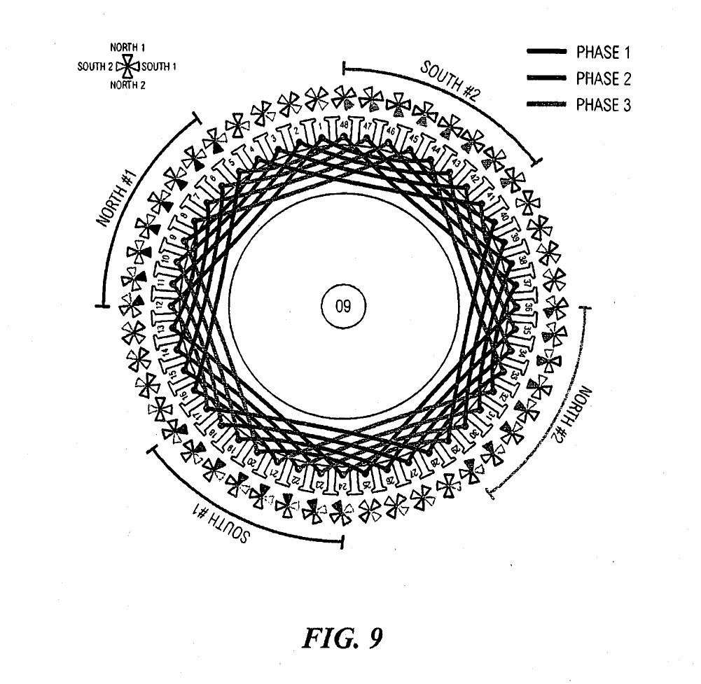

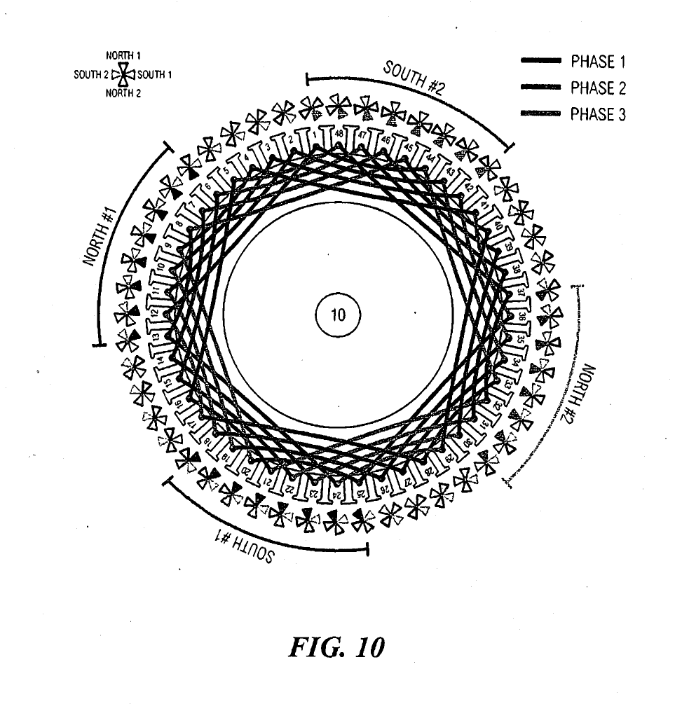

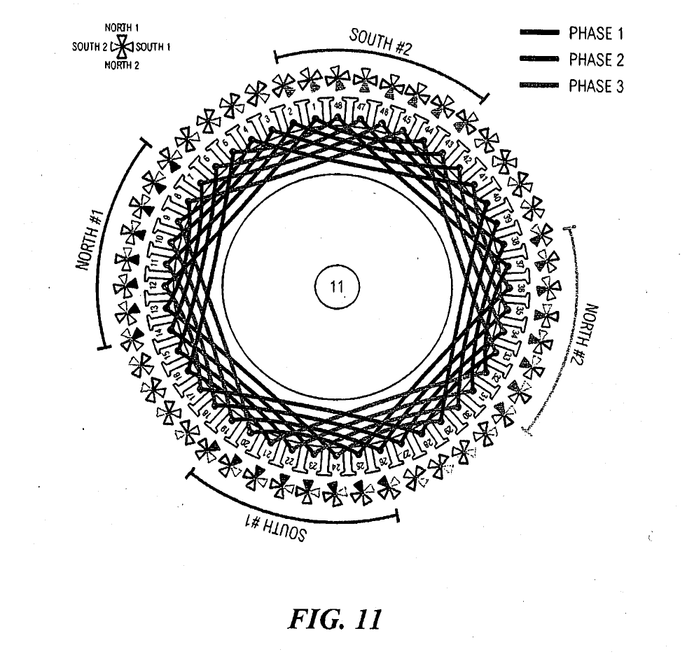

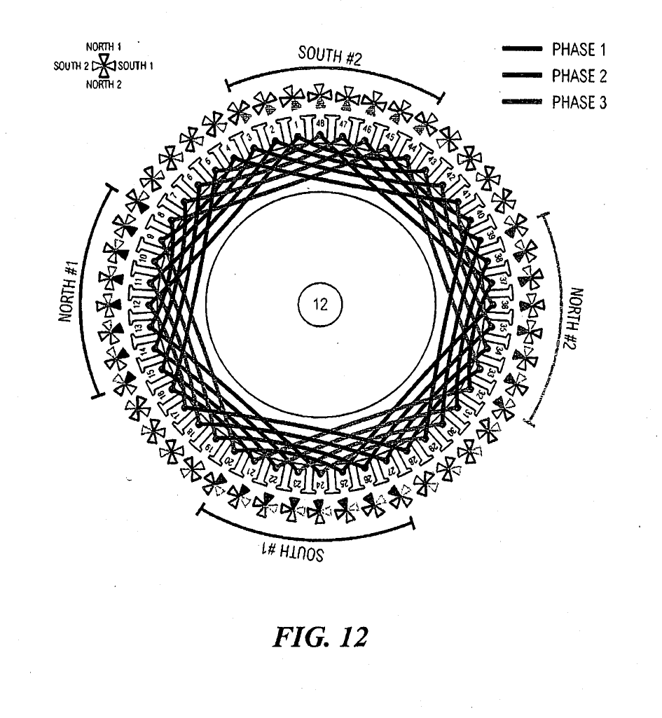

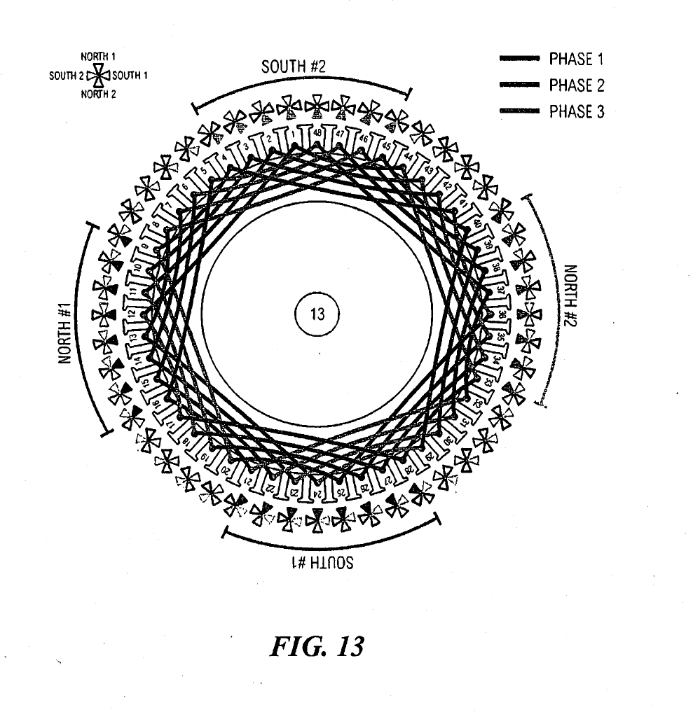

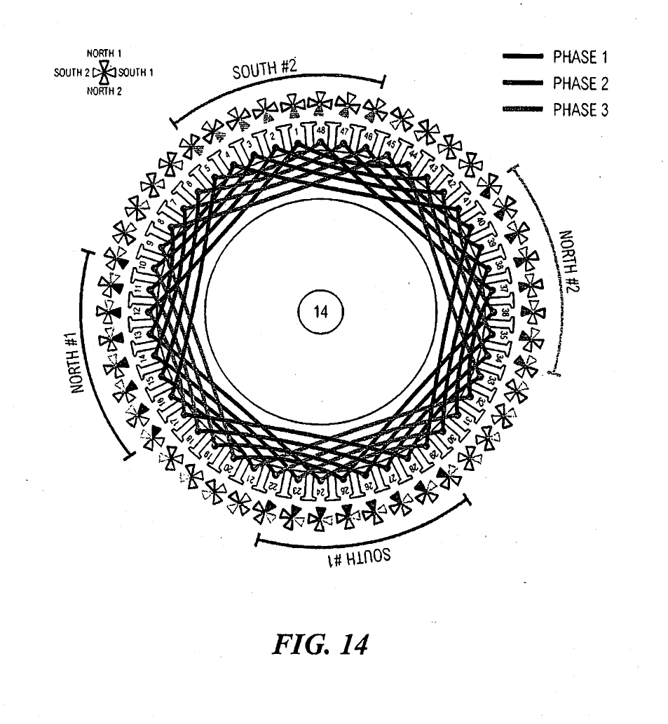

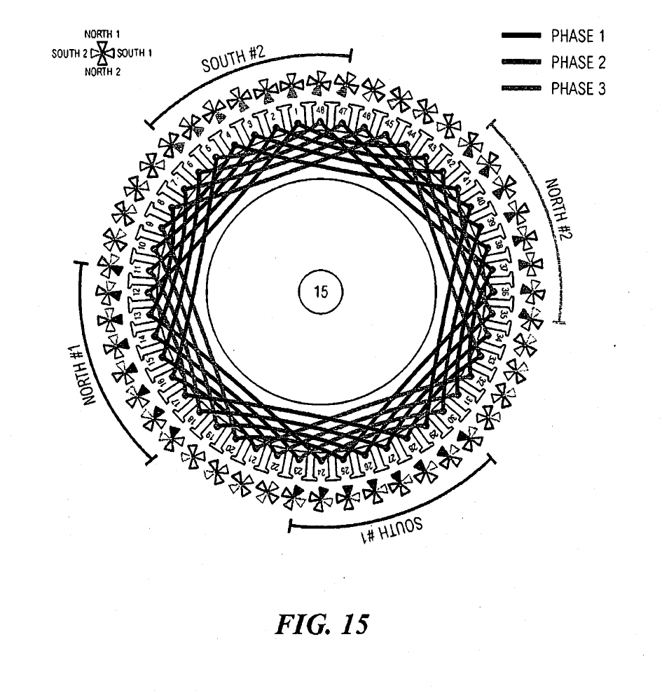

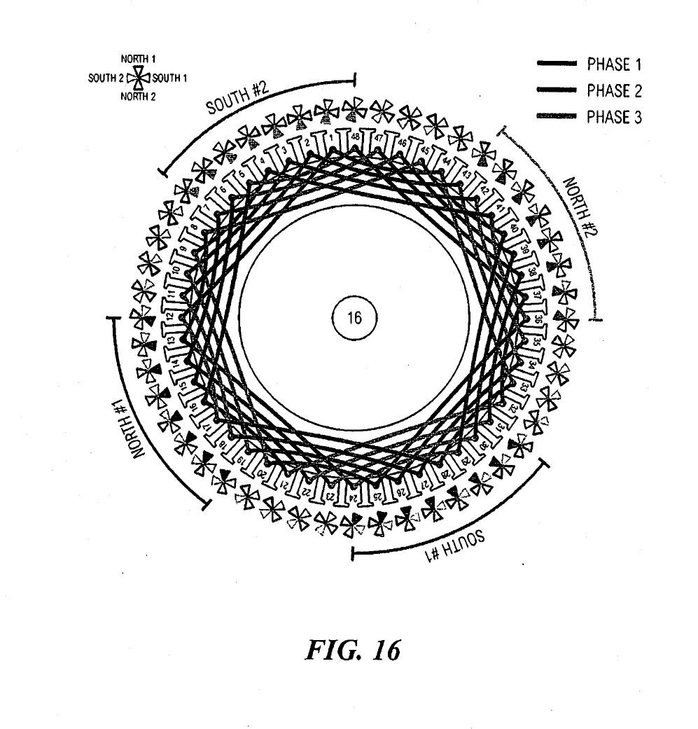

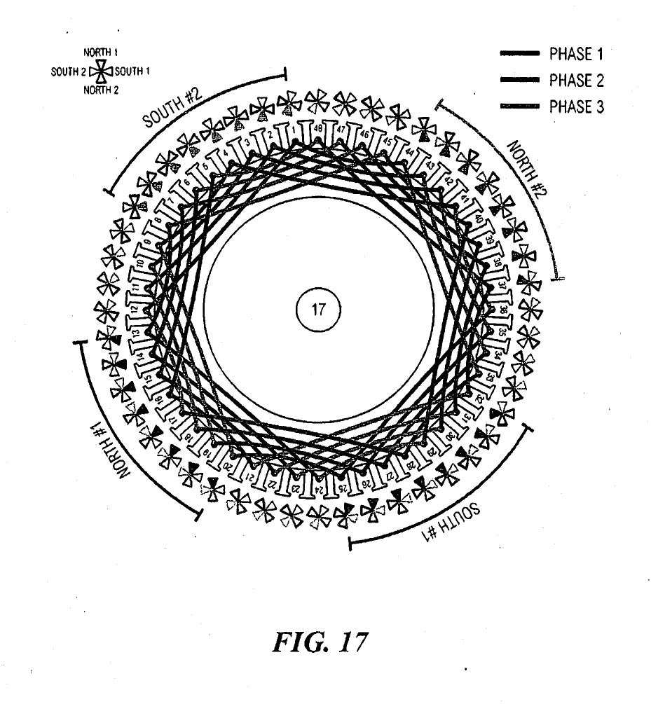

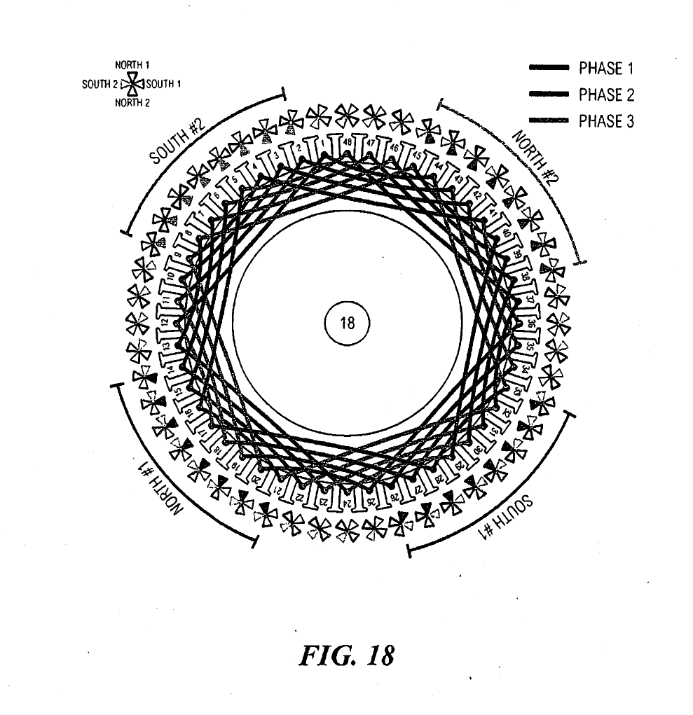

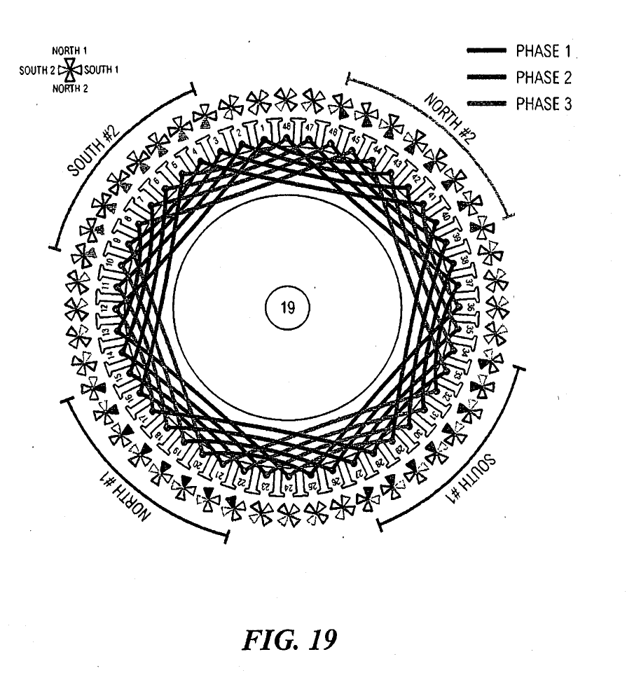

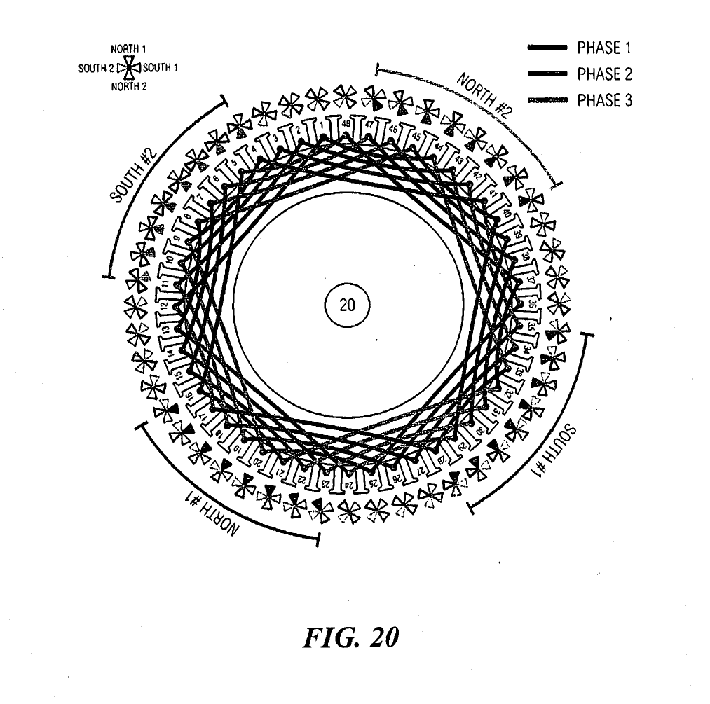

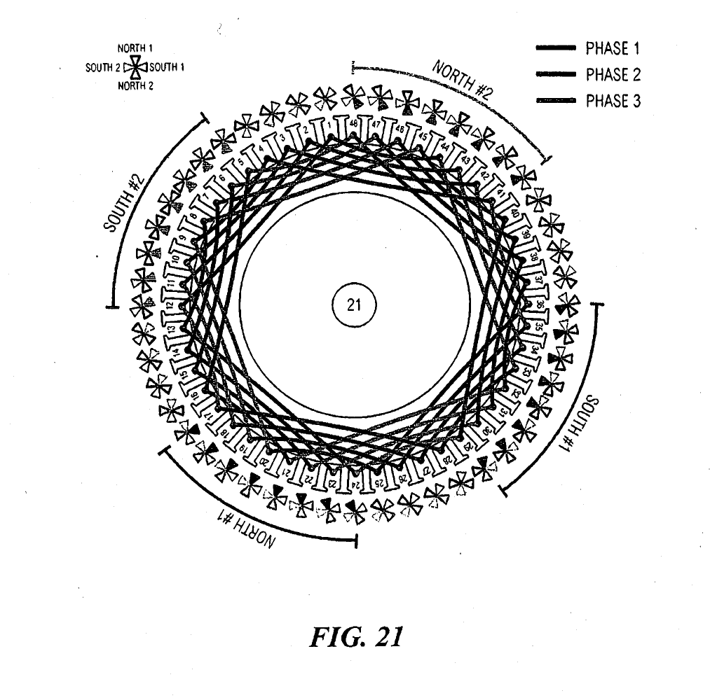

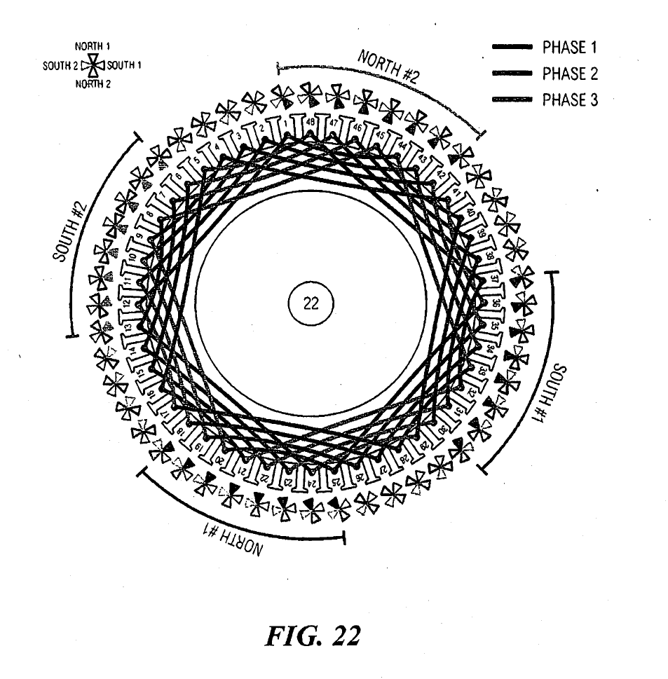

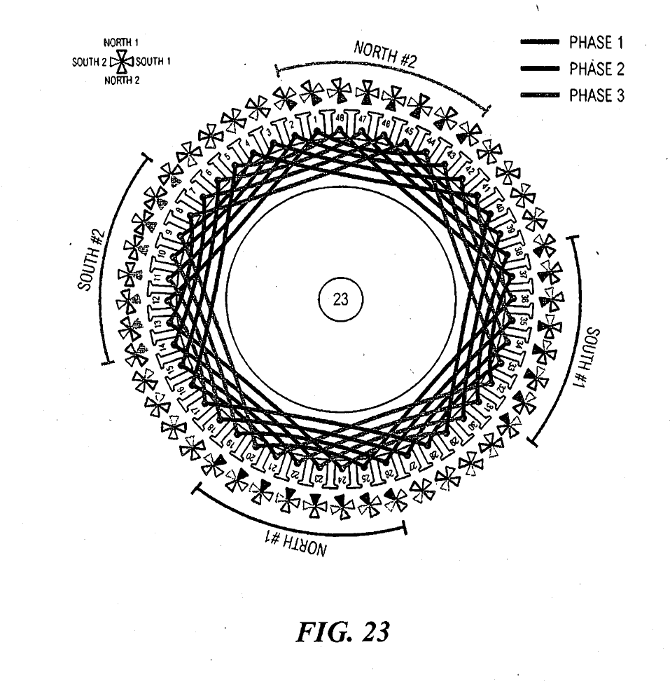

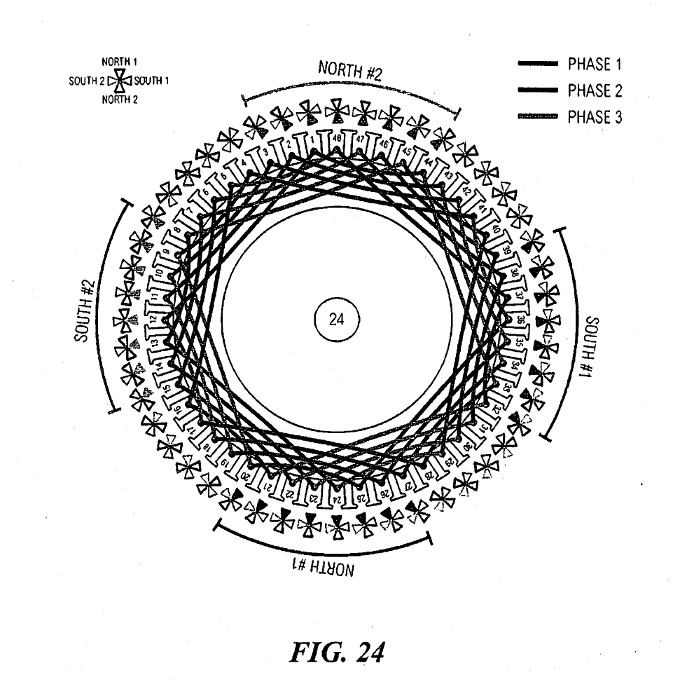

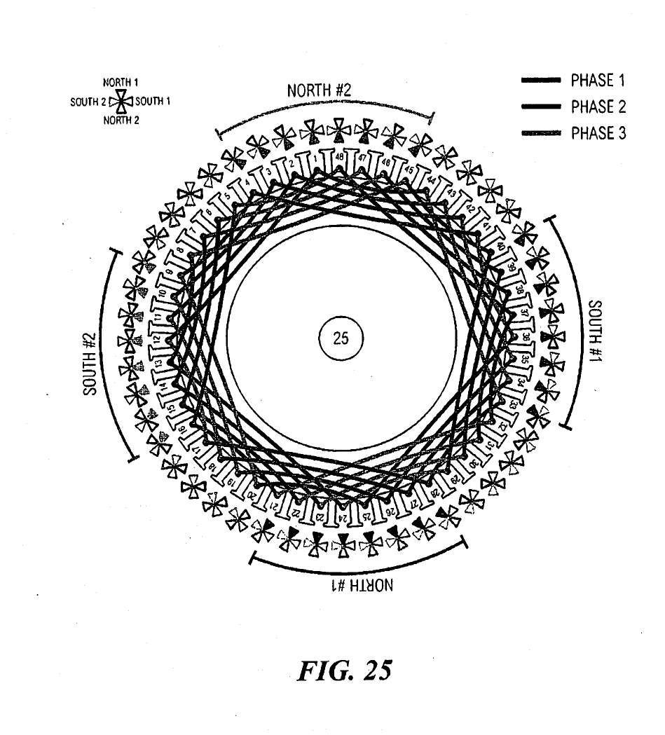

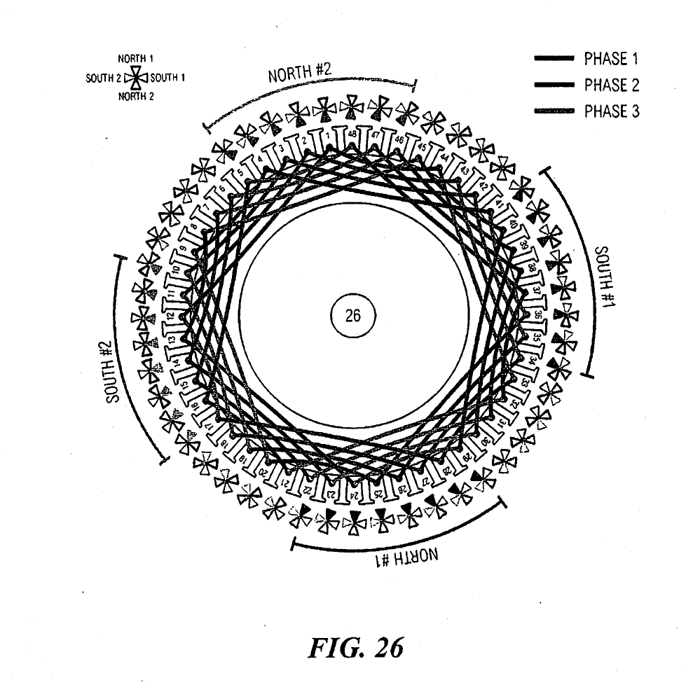

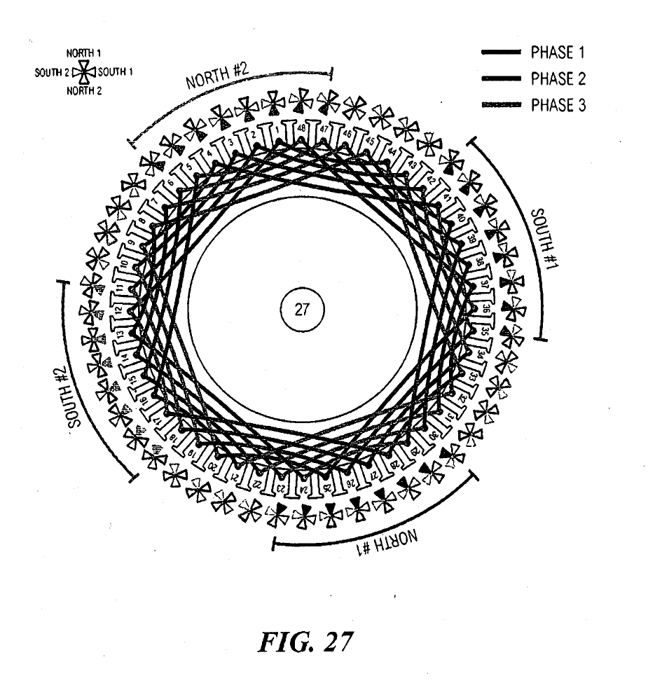

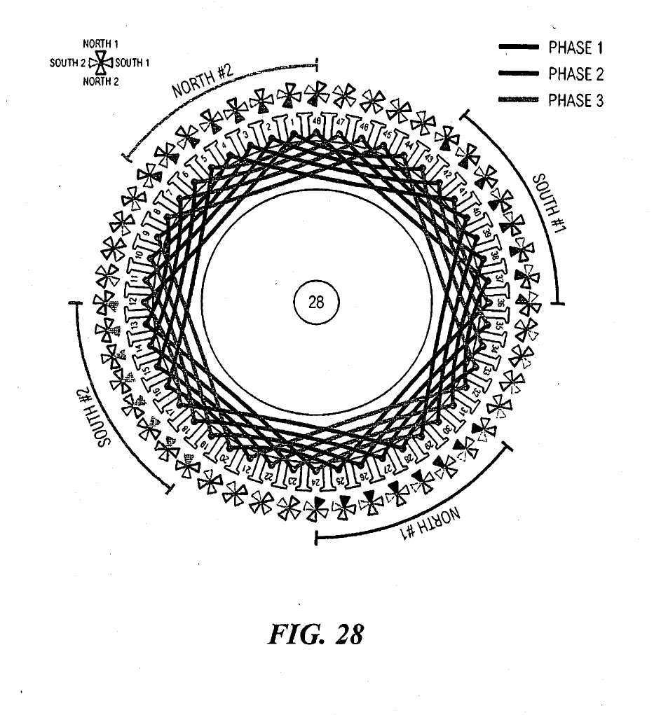

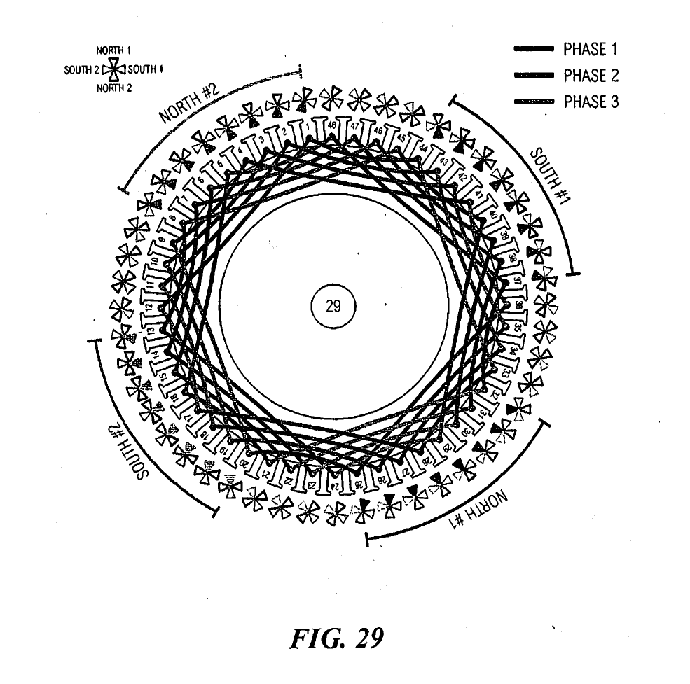

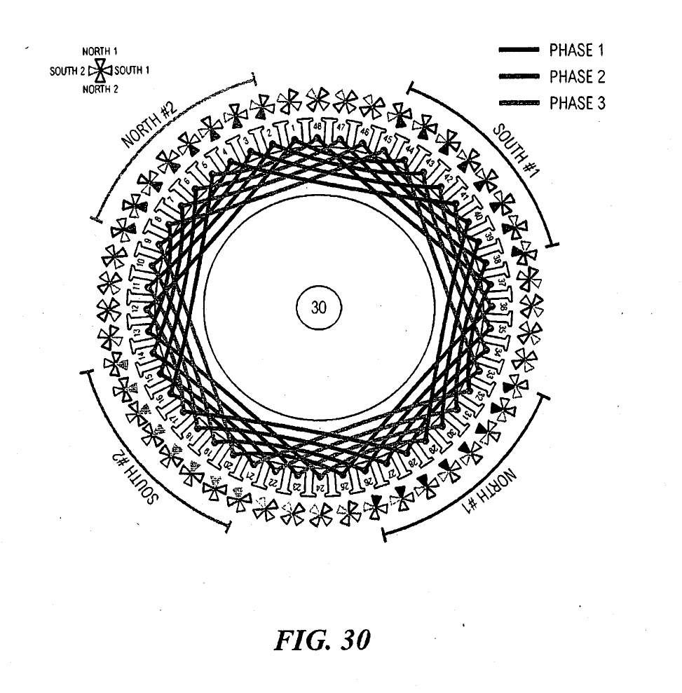

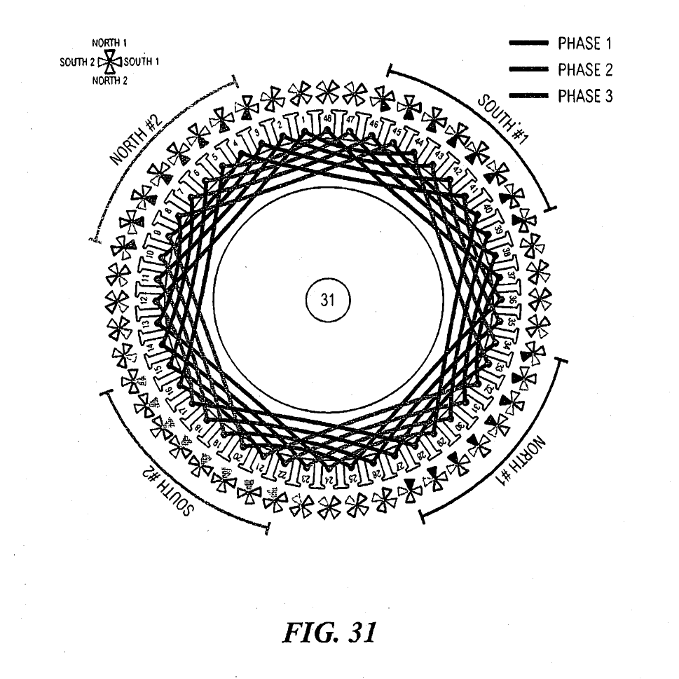

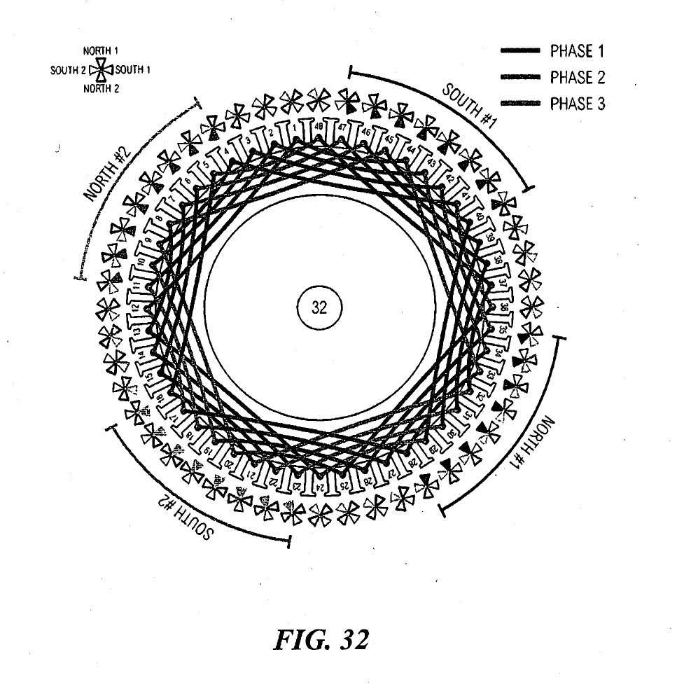

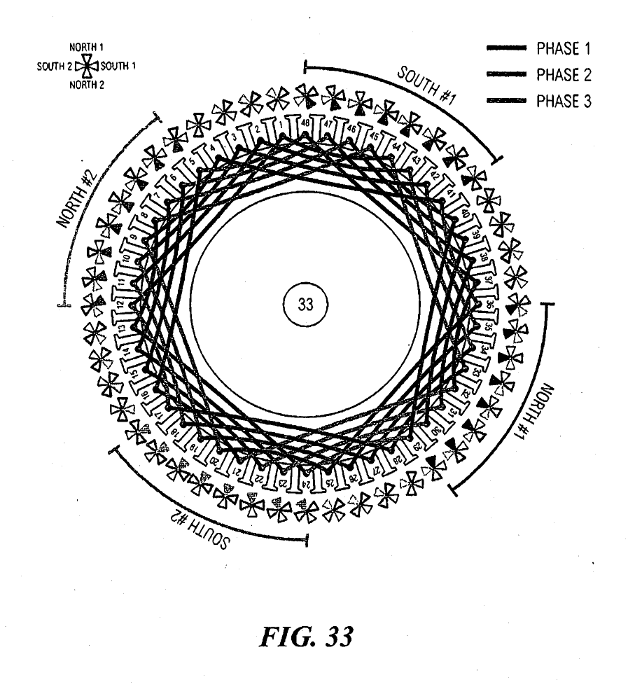

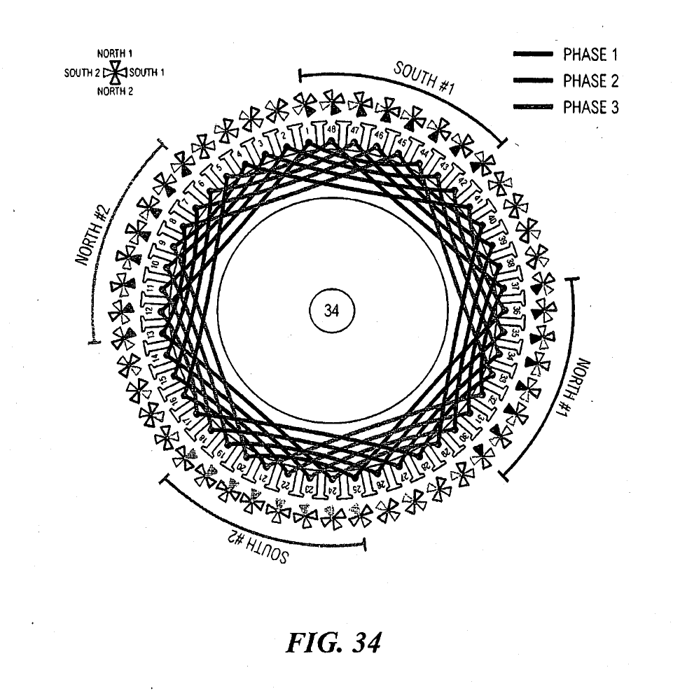

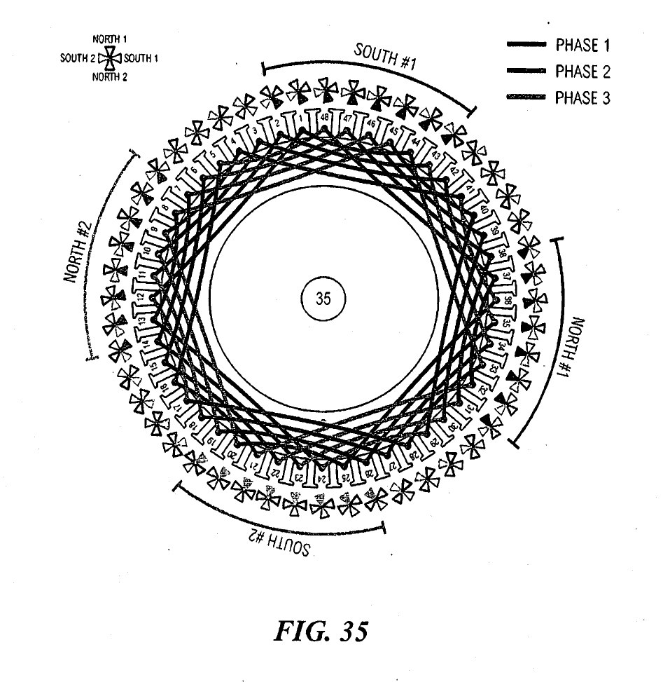

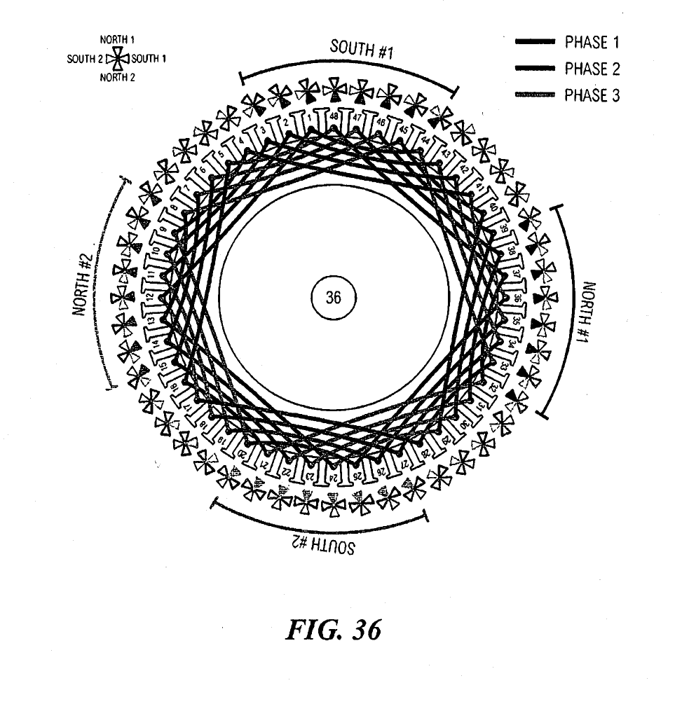

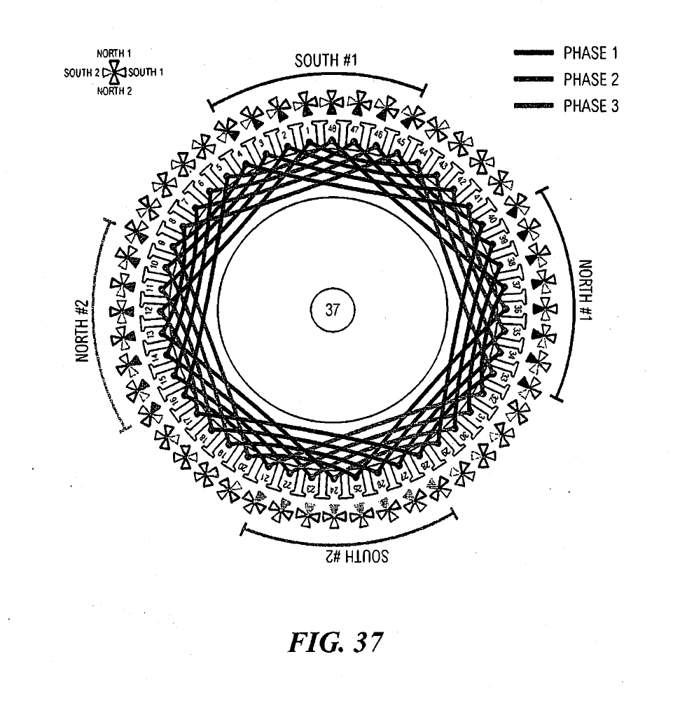

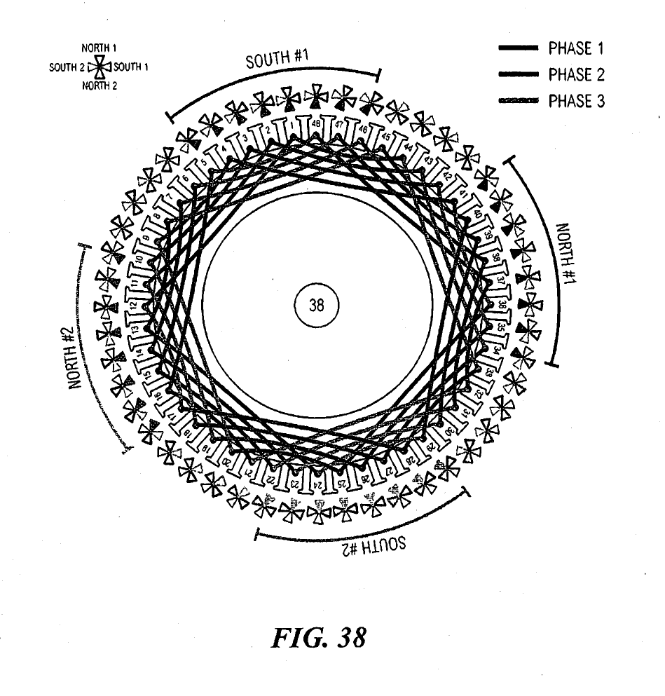

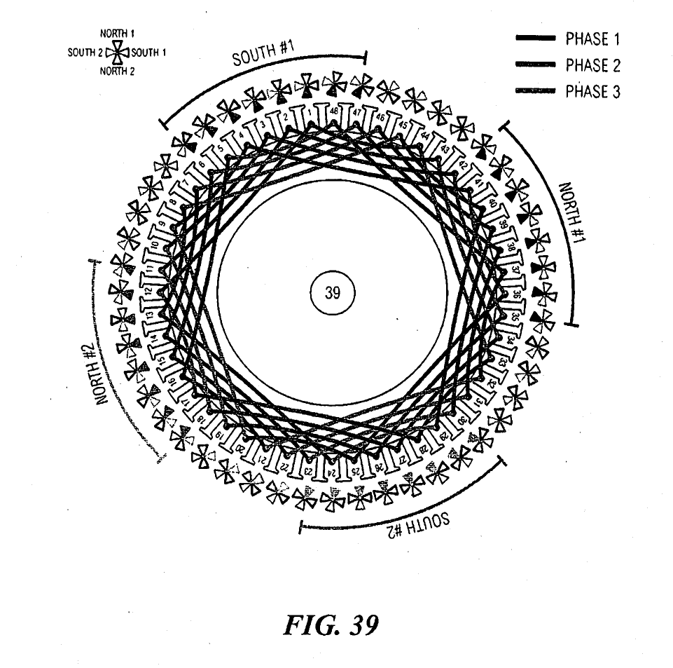

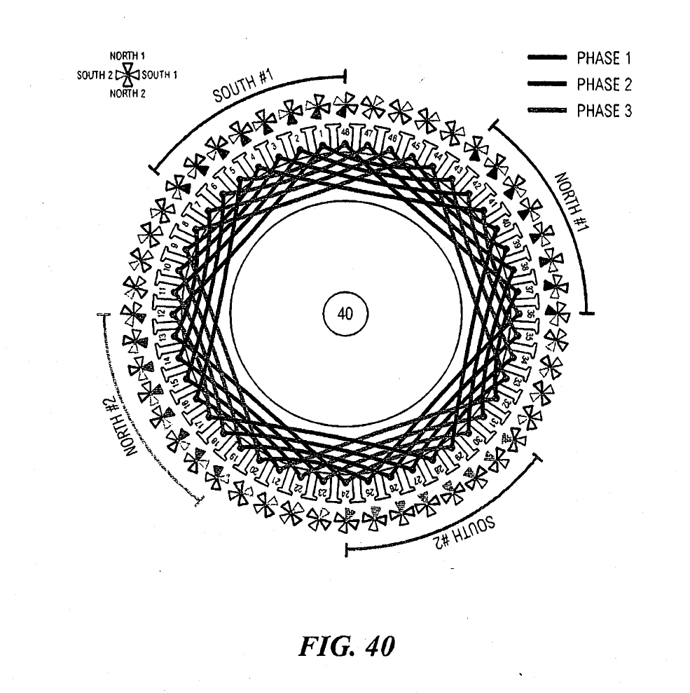

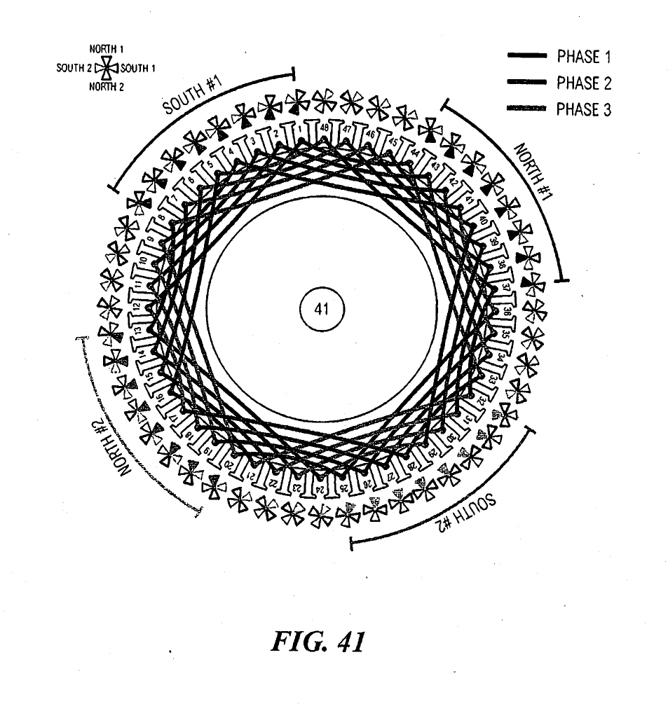

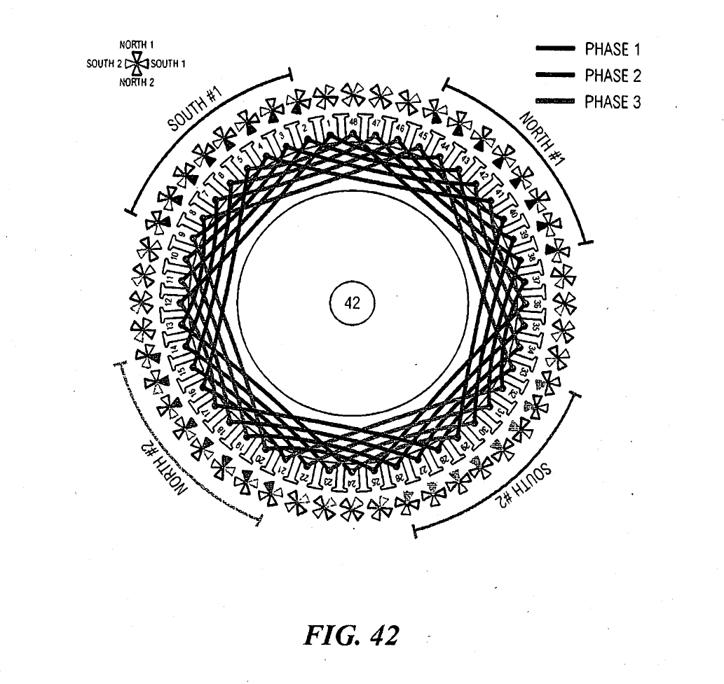

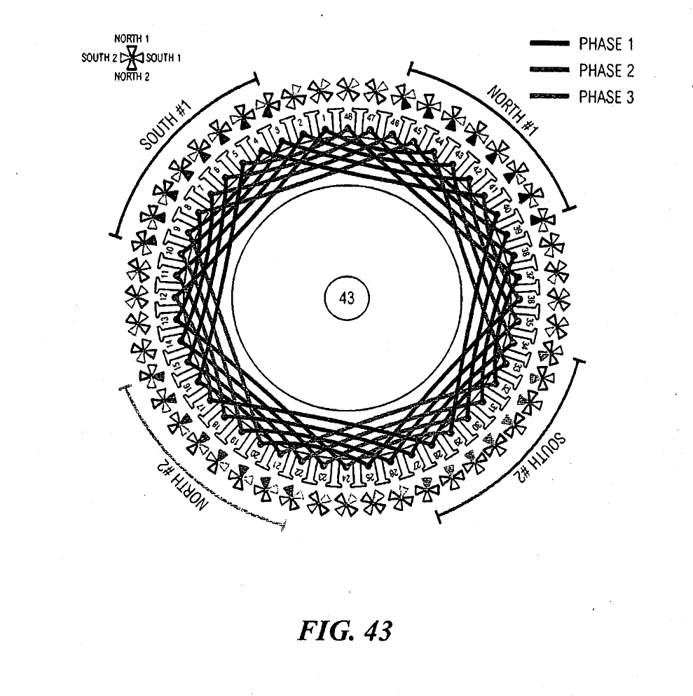

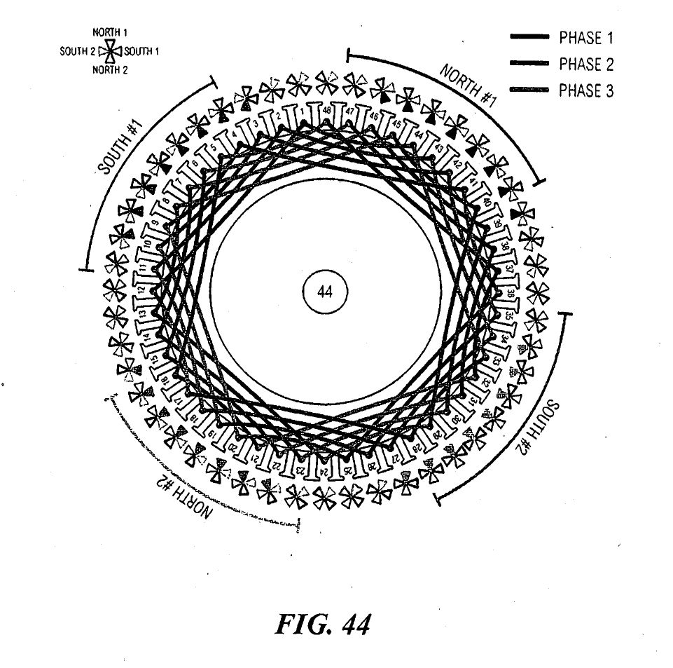

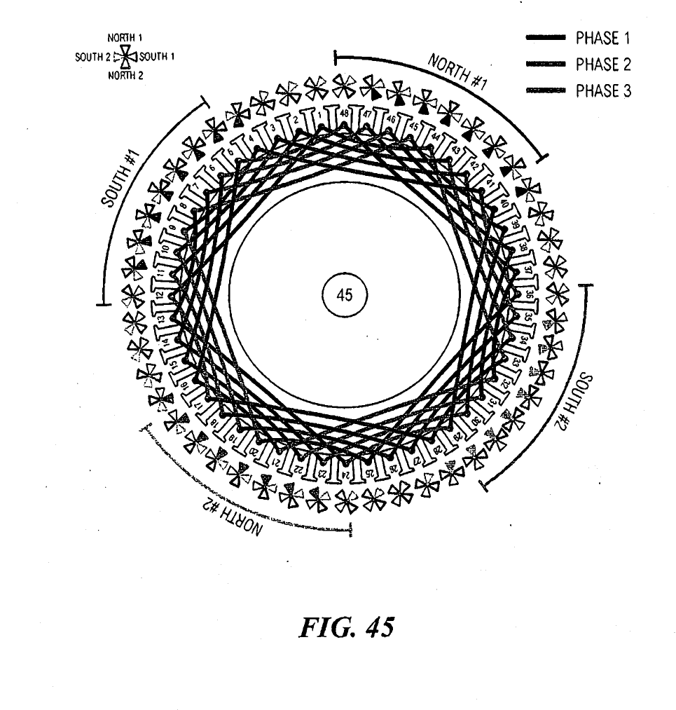

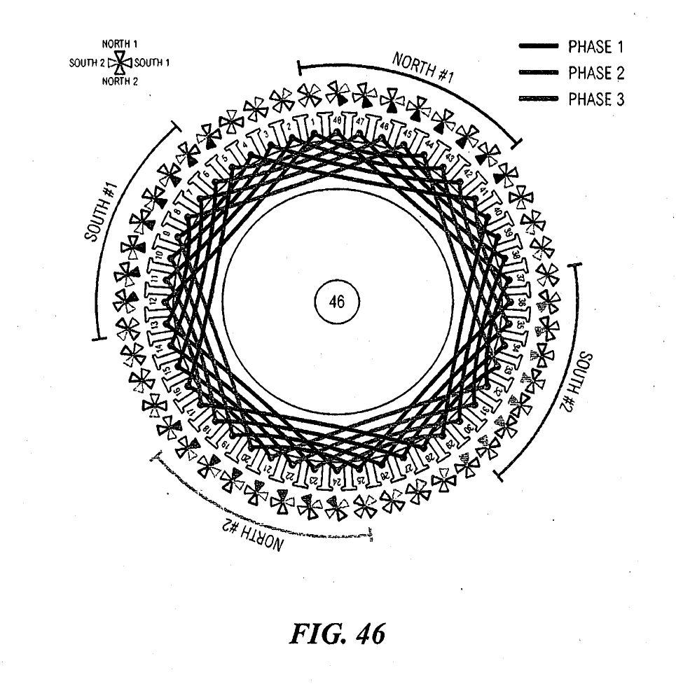

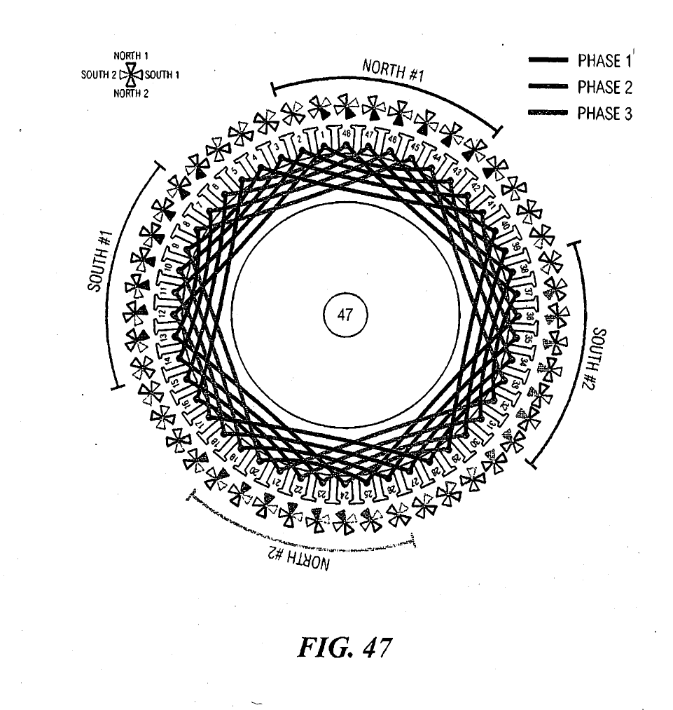

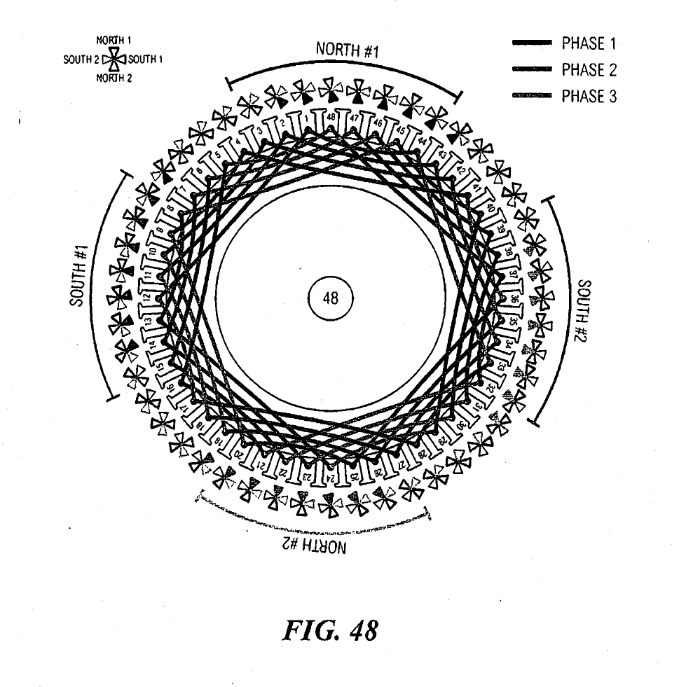

Turning to the figures, reference is first made to FIG. 1, where there is illustrated a schematic end view of the stator of the invention with the 48 armature mechanisms depicted over the wire slots. The laminated steel stator 11 contains a series of 48 slots 8 which contain the induction coils of a 3 phase generator [phase 1 (5), phase 2 (6) and phase 3 (7)] which has a “wye” connection. The rotating north-south-north-south pole energy is separated by areas of magnetic void between each pole (north/void/south/void/north/void/south/void). This arrangement and sequence exactly mimics a standard 4 pole AC 3 phase generator. The 48 4 pole slot armatures are sequenced 7.5° apart for the entire 360° or 48 slots. This sequencing allows magnetic pole energy to send flux across the induction coil wires in 8 slots in a rotating fashion as is depicted by the pole zone markers 1, 2, 3 and 4. The slot armatures 9 spin at 1800 rpm for 60 Hz and 1500 rpm for 50 Hz. These slot armatures 9 spin in a clockwise fashion and the magnetic poles spin around the stator in a counter clockwise fashion. The magnetic void separation between the poles is maintained by a master commentator which only feeds power to the slot armatures needed for pole generation. For example in FIG. 1 as north pole armature [5] (brackets indicate numbers in wire slot space of the Figure) is powered pole armature [45] loses power and is therefore void of any magnetic field. Solid shading of slot armature 9 indicates that power is on and the pole is excited and open, and different shading indicates that the pole is off or not excited. In this same sequence in south pole 4 [17] is powered as [9] loses power. North pole 3 as [29] is powered [21] loses power. South pole 2 as [41] is powered [33] loses power and this sequence continues thereby generating the magnetic flux conditions to generate electric power in the same manner as a classic generator but with greatly reduced electromagnetic drag. FIGS. 2 through 48 are sequential drawings in which the slot armatures rotate 7.5° in a clockwise fashion from the previous Figure.

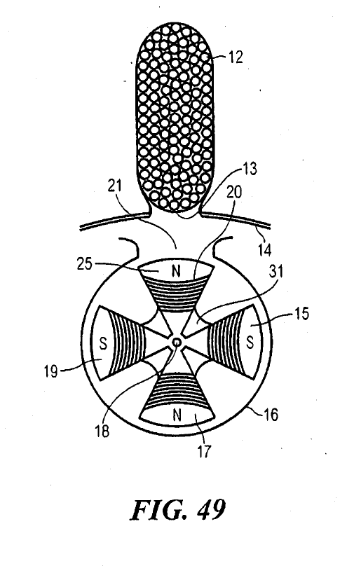

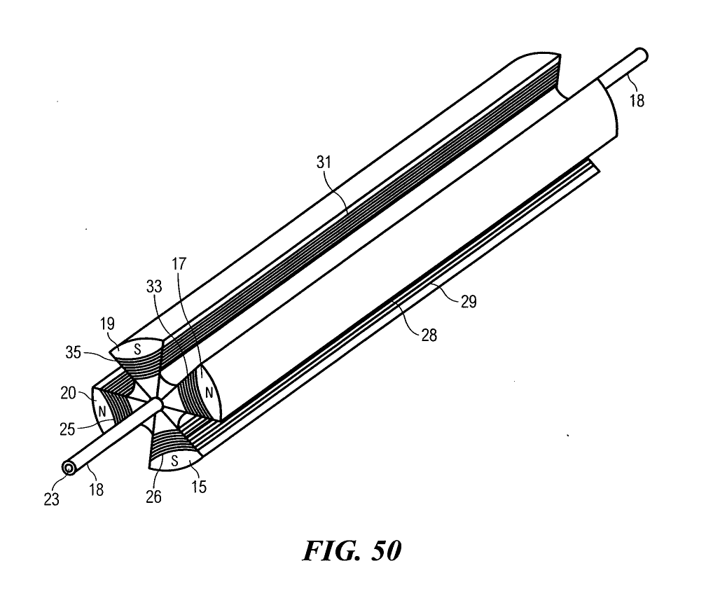

FIG. 49 is an illustration of an electromagnetic slot pole armature mechanism of the invention illustrating the pole winding and mu metal shielding. DC power is fed to the poles 15, 17, 19 and 20 through a neutral and power circuit which emanates from a slip ring and commentator on shaft 18 which has a hollow bore down the center to accommodate the DC conductor wires. Shaft 18 is supported by a bearing assembly contained in a bearing block and supported by a support means on each end. The north poles 17 and 20 are wound in counter-clockwise direction with copper magnet wire. The south poles 15 and 19 are wound in a clockwise direction with copper magnet wire. The neutral is fed constantly via a brush from a slip ring attached to shaft 18 with wire going through the bore 23 of FIG. 50 is in the center of shaft 18 and attached to the neutral of each of the pole windings. The DC current lead is fed to the four pole windings via a brush in contact with a commutator sector such that only one pole is activated at any one time and only as it passes over the wire slot 13 which contains the induction coils 12. As the heads of the electromagnets 15, 17, 19 and 20 rotate past the opening 21 in the mu metal shield 16 the flux lines moving across the copper magnet wire of the induction coils 12 push electrons in the appropriate direction resulting in the generation of electric power. The mu metal shield 14 on the stator and the mu metal cylinder shield 16 separates the magnetic poles of the armature mechanism 31 from the magnetic poles of the stator.

FIG. 50 is an illustration of a superior lateral projection of an electromagnetic slot pole of invention 31. The electromagnetic slot pole 31 is held in close proximity to the stator slot by shaft 18 in an appropriate bearing mechanism which is held in a bearing block which is contained in an appropriate support means. North pole 17 is wound in a counter-clockwise fashion to form pole coil 33. South pole 15 is wound in a clockwise fashion to form pole coil 26. North pole 20 is wound in a counter-clockwise fashion to form pole coil 25. South pole 19 is wound in a clockwise fashion to form pole coil 35.

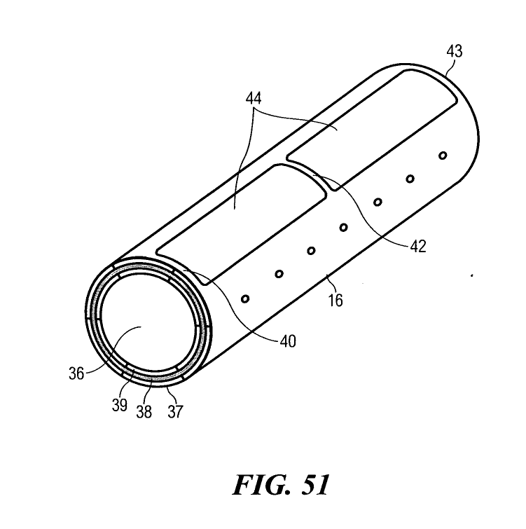

FIG. 51 is an illustration of a superior lateral projection of the mu metal stainless steel laminated sleeve 16 in which the electromagnetic slot pole 31 is contained inside cylinder opening 36. The laminate is made up of a layer of mu metal 39, a layer of stainless steel 38 and another layer of mu metal 37. Slot bridges 40, 42, 43 maintain the integrity of the cylinder. The magnetic flux into the wire slot passes through slot 44.

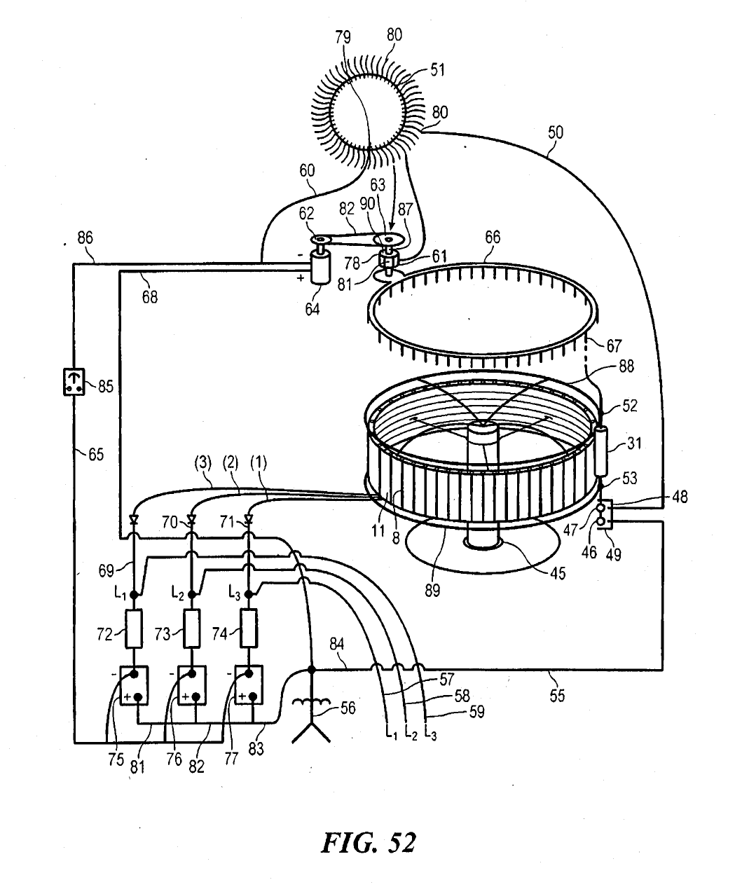

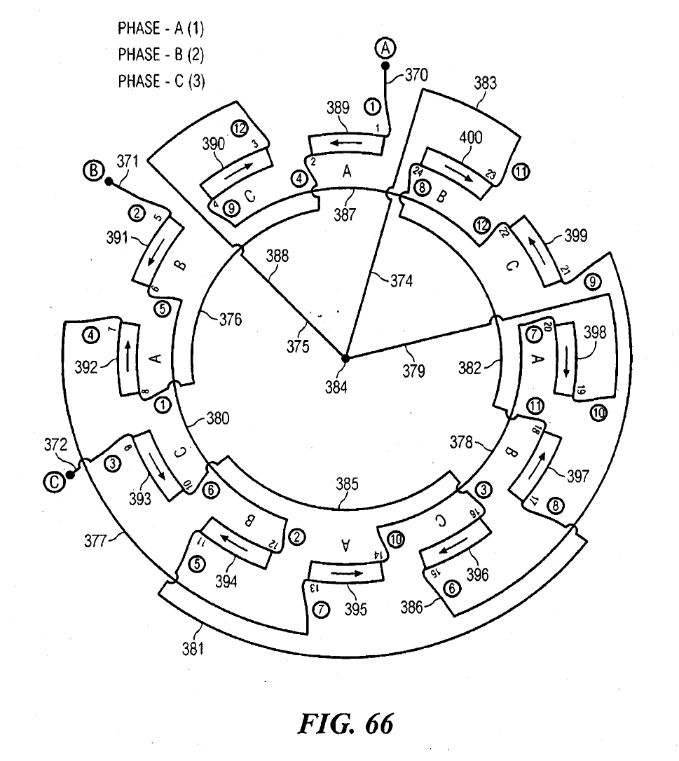

FIG. 52 is an illustration of a schematic view of this embodiment of the invention as it would interact with the power grid in its application. The support frame 45 of the High Efficiency Generator supports the laminated steel stator 11 which contains forty-eight wire slots 8 in which the three phase four pole stator windings of FIG. 1 is wound. The winding is connected in a “High WYE” hookup as in Embodiment II FIG. 66. The output from the generator is through phase (1) 71, phase (2) 70, and phase (3) 69. The three phase legs L-1, L-2 and L-3 are available for connection to the power grid through conductors 57, 58 and 59. The three phase legs also make up with AC/DC bridge rectifiers 72, 73 and 74. The three phase power after being rectified to DC current makes up with batteries 75, 76 and 77. The battery grounds make up through conductors 81, 82 and 83 to ground 56. The square wave variable speed three phase motor 64 which is used to power the generator is powered through conductor 65 and variable speed controller 85 and on through conductor 86. The driver motor 64 makes up its neutral side of the circuit through conductor 68 to ground 56. The driver motor 64 drives pulley 62 which operates belt 82 to drive pulley 63 which drives shaft 87 which carries commentator 90 and drives the gear mechanism of transmission 66 which drives drive shafts 67 which connect to slot poles 31. Slot poles 31 are supported by bearings 52 and 53 which are supported by support means 88 and 89. The electrical sequencing of the four magnetic poles of slot poles 31 is accomplished through master commentator 90 and brush collar 51. Commentator 90 is powered through conductor 60 which powers a master brush 79 which contacts ring contact 78 on commentator 90. Ring contact 78 powers four segments of commentator 90. These four segments 61 each power eight slot poles and are separated by four Insulated segments which cover four slot poles. Each of the forty-eight slot poles are powered by a brush lead 80 through a conduit 50 which connects to a brush 48 which contacts a slot pole commentator 47 which contains two north pole segments and two south pole segments which activate the pole segments only as they pass over the wire slot 8. The circuit is completed through slip ring 46 to brush 49 through conductor 55 to neutral 56. The design of master commentator 90 as described above allows segments of eight slot poles to be powered separated by four slot poles which are not powered. Thereby generating two north poles which each cover eight slots and two south poles which each cover eight slots and all are separated by four slots which are unpowered just as is the case and generates an identical field as that generated by a standard four pole three phase generator rotor.

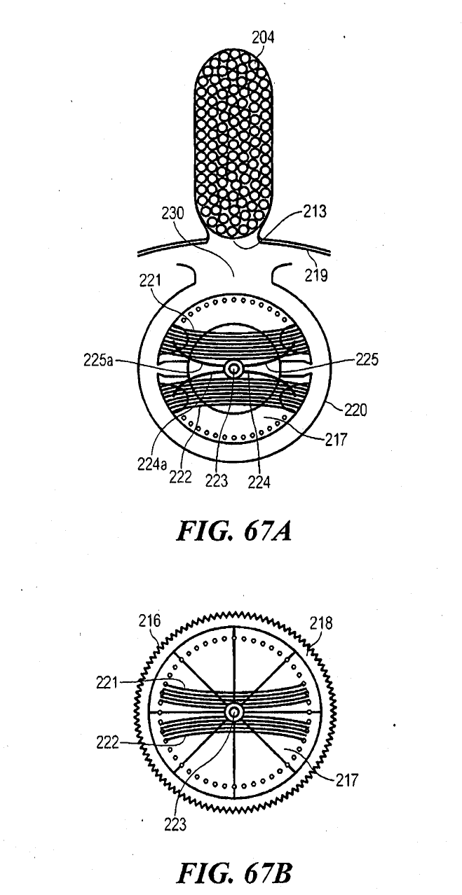

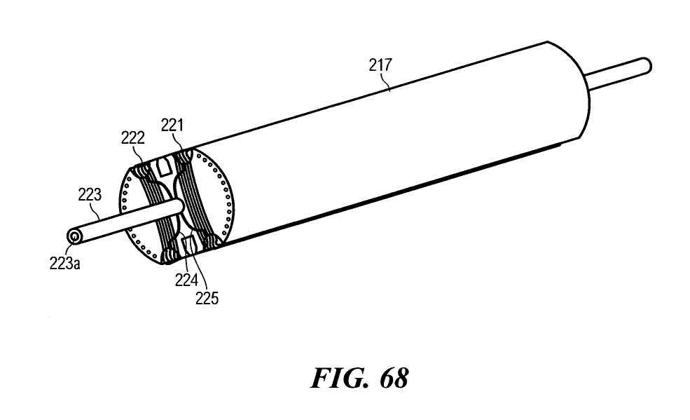

In another embodiment shown in FIGS. 67A-B and 68, the cavity contains a containment means and bearing for the bipolar electromagnetic bars 217 shown in FIG. 67A-B and FIG. 68. The containment means and the magnetic bars are rotated in sequence such that the rotating magnetic field approximates the effects of a rotating armature but without the accompanying electromagnetic drag. The bipolar electromagnetic bars in their containment means are rotated on their axis via a gear mechanism 218 FIG. 67B by contacting the gear cogs 216 on a support means which are attached to a wheel driven by a shaft 223. The stator iron is pressed into the generator housing. The leads are made up and pulled to the outside of shell. The electromagnetic bars 217 FIG. 67A-B and FIG. 68 are aligned in sequence prior to the cylinder being pressed into the stator. When the electromagnetic bodies are in proper sequence and gear wheel are meshed properly with cog 218 they are locked together by a means such as a pin. The cylinder is then pressed into place inside the stator and attachment means are secured. The lock pins are then removed. Electromagnetic slot pole support means is then attached to cylinder insert as shaft 223 is placed through bearings in support means. Lead wires from the electromagnetic coils 221 and 222 FIG. 67A-B are pulled through a bore hole in the center of shaft 223 FIG. 67A-B and out to slip rings and then the circuit progresses to the brushes attached to leads which attach to DC power supply. Slip rings allows activation at any point in time of only the pole which is passing the wire slot to be activated and allows alternating north and south poles to be activated respectively. The brushes are held in contact with the slip rings by support means. End bells are applied by pushing shaft through end bell opening into bearings. Bolts are then placed through the end holes and nuts are applied to the bolts which in turn are tightened down to the proper torque.

Now we will consider several details of the construction of this embodiment. FIG. 67A-Bare representation of a cross section of the bipolar electromagnetic induction bar 217 shaft 223 pulley 218 and wire slot 204 along with shielding means 219 and 220. The magnetic flux is only activated in both and north and south poles via a DC exciter current delivered by the slip rings in lead wires which traverse through the hollow shaft 223 to leads 224, 225, 224a and 225a FIG. 67A-B. The neutral side of the circuit is constantly closed through slip ring which has a conductive surface throughout its 360° circumference. The power side of the circuit feeds coils 221 and 222 FIG. 67A-B through slip ring such that 120° of the slip ring feeds the north pole as it rotates across the wire slot for the full 120°. There is 60° of insulated surface on slip ring. After the brush activates the 120° north pole segment the insulated portion of the slip ring allows the circuit to open as the brush travels across the 60° insulated segment of the slip ring, it then activates the south pole segment for 120° of exposure to the wire slot as it travels across the opposite active segment of the slip ring thereby closing the DC circuit for the said south pole segment. Any magnetic flux interaction between the stator and the rotating armature pole is shielded except over the stator slot opening 213 FIG. 67A by laminated stainless steel and mu metal shielding 219. The open slot 213 FIG. 67A-B allows magnetic flux to move through the shield slot 230 FIG. 67A-B and move past the winding magnet wire in the wire slot thereby pushing electrons through the coils and generating voltage in the induction coils. When the induction coil circuit is closed to a load, current will flow and therefore voltage multiplied by amperage creates power with little or no electromagnetic drag. This design yields much greater efficiency when compared to a standard generator.

### Embodiment II

### Electric Power Generator with Reduced Drag

The structure and mechanism of this embodiment of the present invention will allow electric energy to be generated by the current fossil fuel driven mechanical energy source with greatly increased efficiency, therefore less fossil fuels will be consumed and therefore less production of greenhouse gases will result. The present invention also allows magnification of electric energy.

The enhanced efficiency is obtained due to the removal of electromagnetic drag from the system. The classic armature is replaced by a cylinder which is pressed into the stator. The cylinder contains Mu Metal shielded cavities which in turn house a bipolar magnetic bar assembly which is rotated to provide alternating north and south pole energy into the open wire slots of the induction coils in the stator. The Mu Metal laminated shield is only open precisely over the wire slot. Therefore minimal drag occurs upon the spinning bipolar magnetic bars.

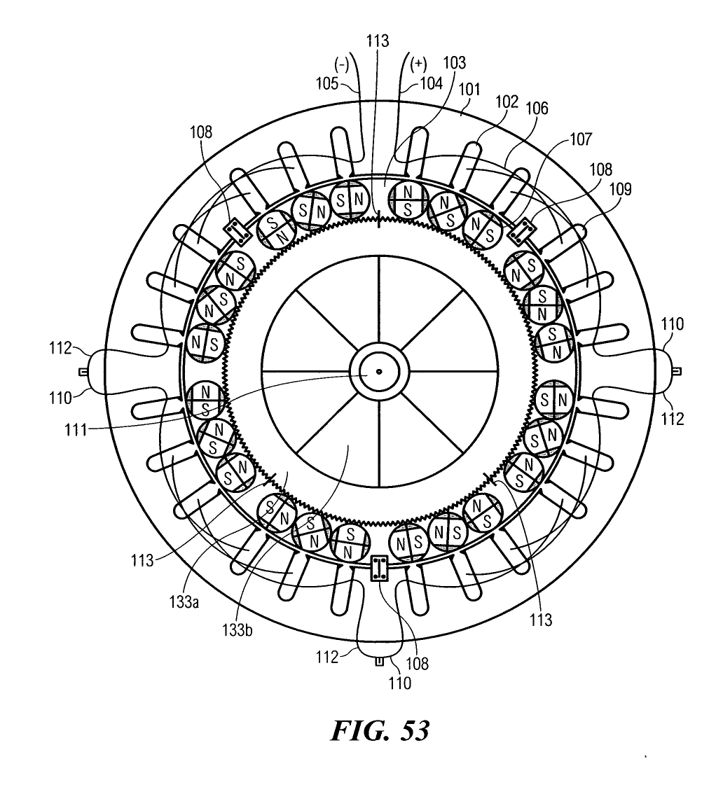

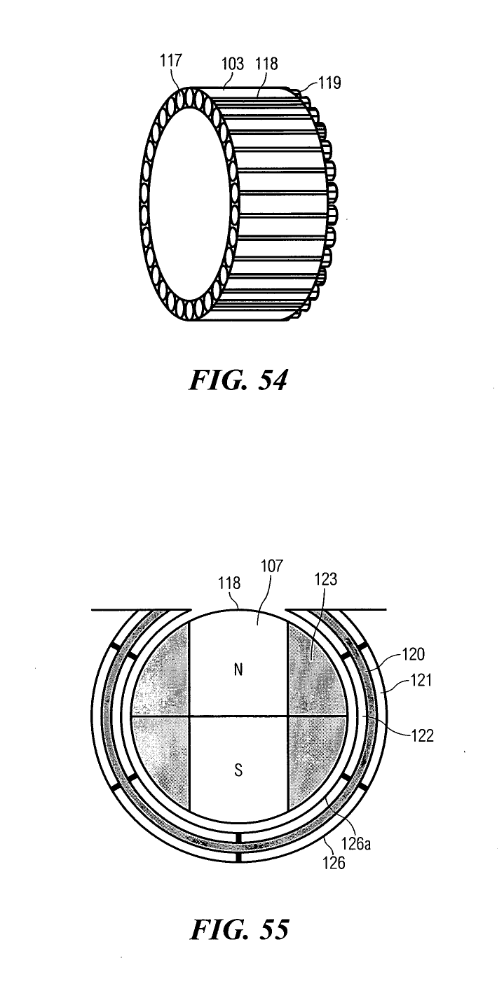

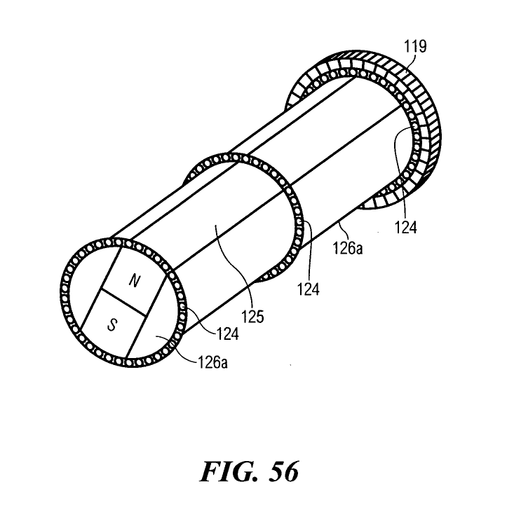

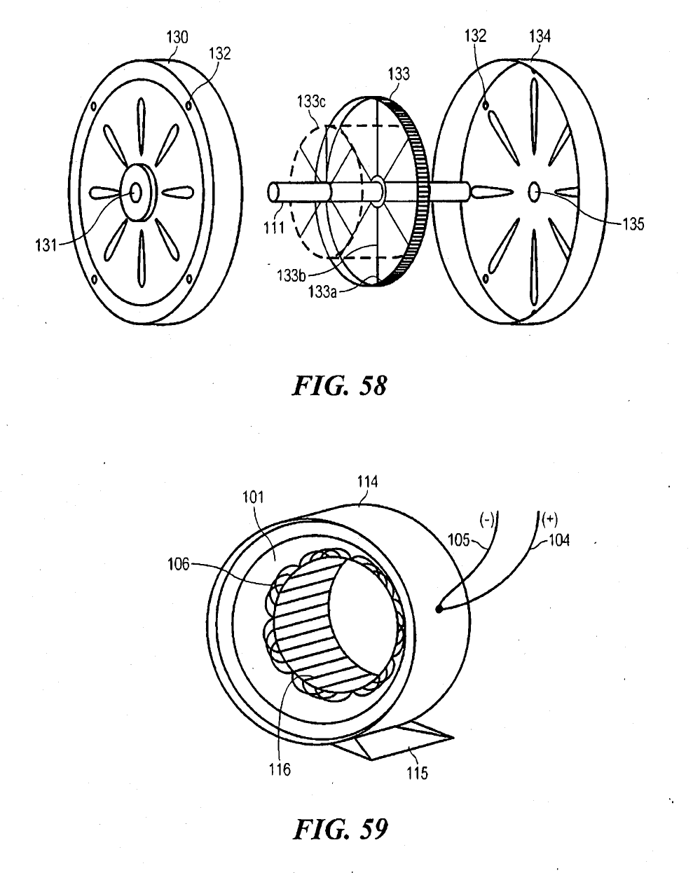

Turning to the Figures, reference is first made to FIG. 53, where there is illustrated a schematic end view of the stator of the invention which contains the armature mechanism insert. The laminated steel stator 101 contains a series of slots 102 which contains the superior portion of the coils and 109 which contains the inferior portion of the coils. In this particular depiction the winding is single phase with 4 groups of coils and 3 coils per group. The first coil of the group of 6 inlaid into slot #1 and slot #4. The second coil of the group is laid Into slot #2 and slot #5. The third coil of the group is laid into slot #3 and slot #6. The remaining 3 coil groups are placed in the wire slots in the same fashion. Lead 104 of the first coil group remains free and becomes generator neutral. Each coil group is made up with the adjoining group by making a connection between power lead 110 of each group to the neutral 112 for each group. The power lead 105 in group 4 becomes the power lead of the generator when all of the coil groups are wired together. Stainless steel insert 103 contains a number of circular cavities which pass completely through the wall in proximity to each wire slot in laminated stator 101. The cavity 117 in FIG. 54 is unroofed to match the width of the wire slot opening in laminated stator 101 of FIG. 53. The cavity 17 FIG. 54 contains a containment means and bearings for bipolar magnet bars 107 in FIG. 53. The containment means and the magnetic bars are rotated in sequence, such that the rotating magnetic field approximates the magnetic effects of a rotating armature but without the electromagnetic drag. The bipolar magnetic bars in their containment means are rotated on their axis via a gear mechanism 119 FIG. 56 by contacting the gear cogs 133 on support means 133a in FIG. 58 which are attached to wheel 133b FIG. 53 and FIG. 58 driven by shaft 111 FIG. 53 and FIG. 58. The stator iron 101 is pressed into the generator housing 114 FIG. 59. The leads 104 and 105 FIG. 59 are made up and pulled to the outside of shell 114 FIG. 59. The magnetic bodies 107 FIG. 53 are aligned in sequence prior to the cylinder 103 FIG. 54 being pressed into the stator. When the magnetic bodies are in proper sequence and gear wheel 1338 and cylinder 103 are locked together by pins 113 FIG. 53. Cylinder 103 is then pressed into place inside the stator 101 and attachment means 108 FIG. 53 are secured. Lock pins 113 are then removed. End bells 130 and 134 FIG. 58 are applied by pushing shaft 111 FIG. 58 through into bearings 131 and 135 FIG. 58, with 133c FIG. 58 being used as a guide. Bolts are then placed through end holes 132 and bolt nuts are applied and tightened.

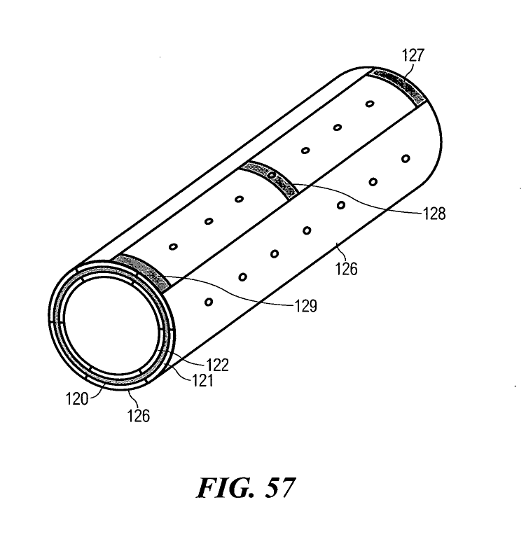

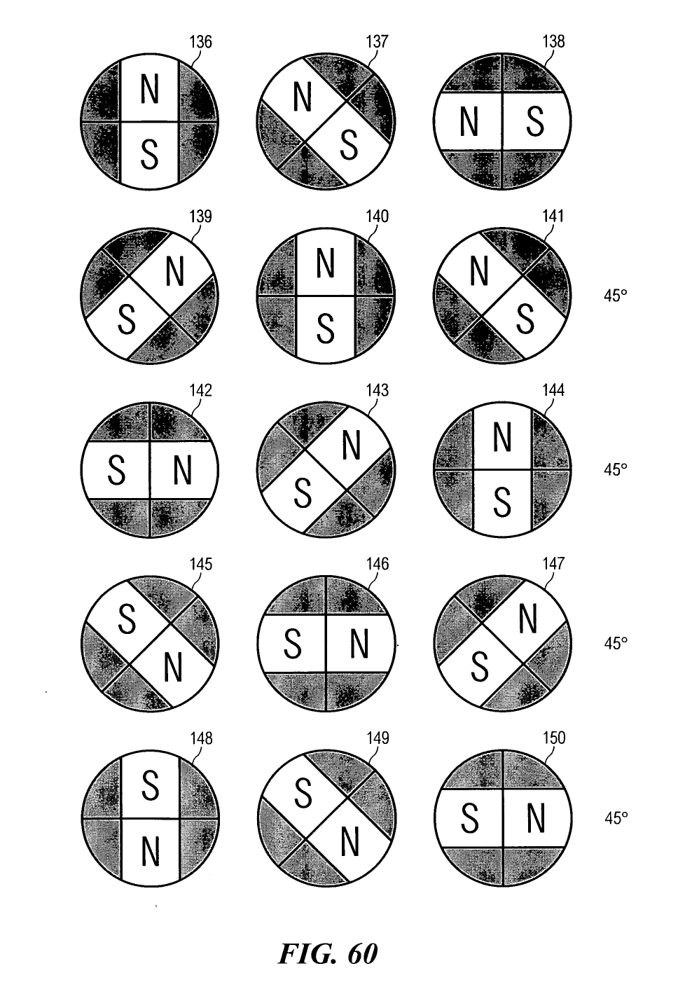

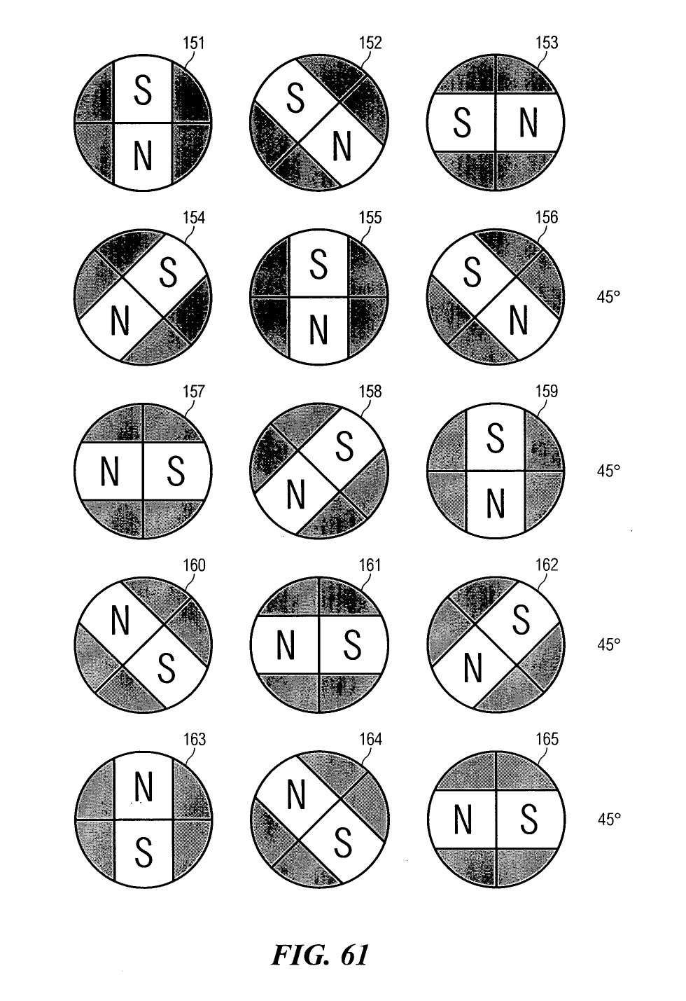

Now we will consider several details of construction. FIG. 55 is a representation of a cross section of the bipolar magnet bar containment means and shield 126. The magnetic flux is shielded except over the stator wire slot opening 118 by laminated stainless steel 121, Mu Metal 120 and steel 122. The magnet bar 107 is glued into stainless steel containment means 126a. FIG. 56 represents a lateral elevated view of the magnet bar containment means 126a. The open slot 125 allows magnetic flux to move through the shield slot 118 and move past the winding magnet wire in the wire slots thereby pushing electrons through the coils. Containment means 126a rotates inside laminated shield 126 FIG. 54 and FIG. 57 on bearings 124 FIG. 56 pulled by gear mechanism 119 FIG. 56. FIG. 57 represents an illustration of a superior lateral projection of the Mu Metal stainless steel shield for the pole containment means, which reveals bearing rests 127, 128 and 129. FIG. 60 represents the synchronous rotation through 180° of the north pole magnets of the invention revealed in 45° increments. FIG. 61 represents the synchronous rotation through 180° of the south pole magnets of the invention revealed in 45° increments.

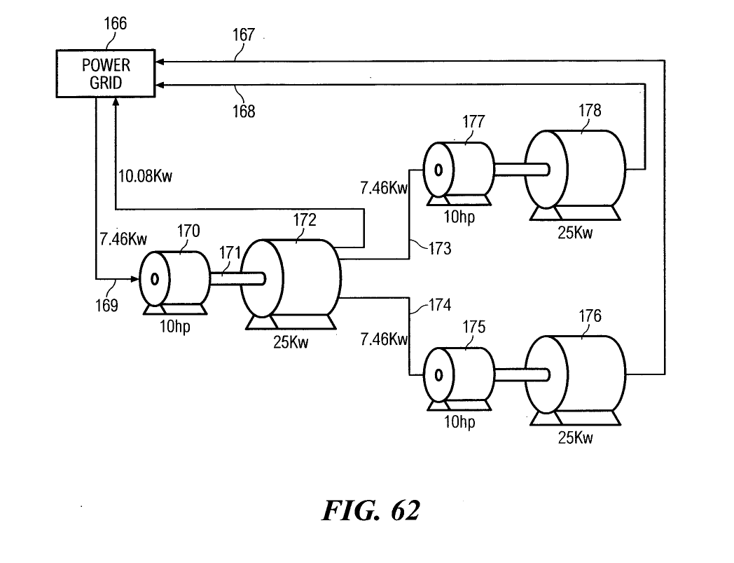

FIG. 62 is a conceptual representation of the method by which the invention can be used to magnify power from the grid and place the newly generated power back onto the power grid. The values quoted are estimates based upon preliminary data. Power is taken from the electric power grid 166 via conduit 169 (7.46 kw) to drive 10 hp motor 170. The 10 hp motor 170 pulls 25 kw generator 172 through shaft 171. From the 25 kw power output 10.08 kw is fed back to the power grid and 7.46 is fed to each of 2 electric motors 177 and 175 via conduits 173 and 174. Generators 178 and 176 generate an additional 25 kw each which is fed back to the power grid via conduits 167 and 168. It can readily be seen by one skilled in the art that the power feed to the grid can be continually expanded. An alternate method is to replace the permanent bodies of the rotor with wound electromagnetic bodies as in embodiment I and provisional patent application USPTO No. 61/269,755-Inductive Magnetic Armatures As Components of Decreased Drag Electric Generators.

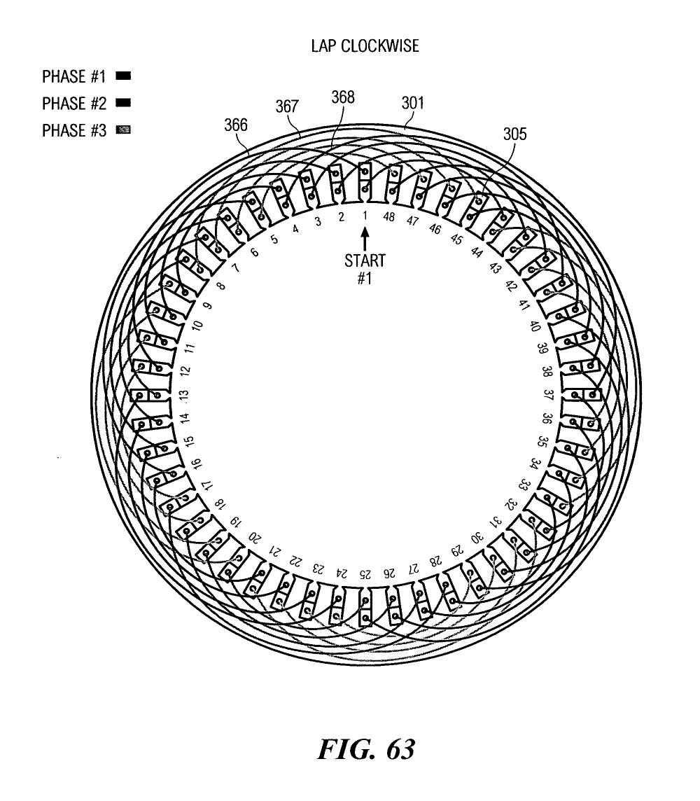

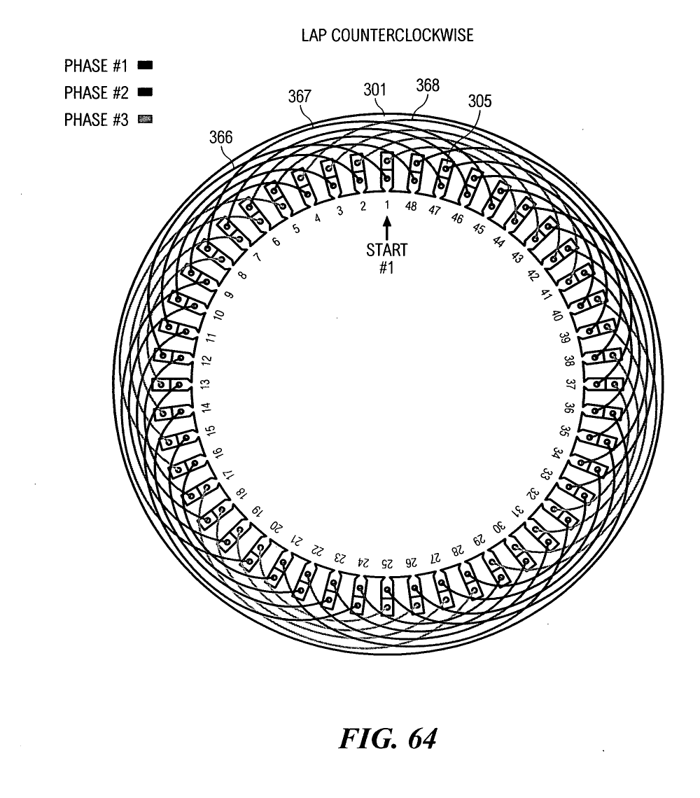

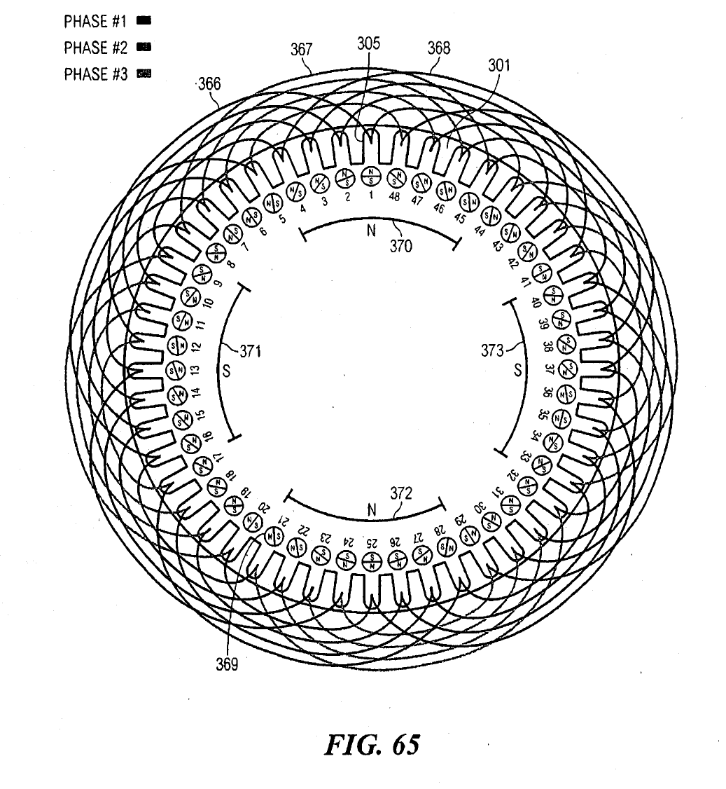

FIG. 63 is a diagrammatic representation of the wound stator of an embodiment of the invention. The stator iron 301 contains insulated wire slots 305 in which 12 phase coils are wound. There are 3 phases with 4 coils per phase coil. Phase coils 366 (phase 1) 368 (phase 2) and 367 (phase 3) are lapped and arranged such that the 4 pole rotor will generate the 3 phase 120° electrical degrees separated. The lap winding is clockwise. FIG. 64 is the same as FIG. 63 except that the lap winding is counter clockwise. FIG. 65 represents the same 3-phase winding as FIGS. 63 and 64. In addition FIG. 65 represents the permanent slot pole magnetic bodies 369 which are sequenced such that they form moving magnetic poles as they spin over the slots. North pole depiction 370 sends north pole flux into slots 4, 3, 2, 1, 48, 47, 46 and 45. Slots 5, 6, 7 and 8 are neutral and south pole 371 depiction covers the area where the spinning magnetic poles puts south pole flux into wire slots 9, 10, 11, 12, 13, 14, 15 and 16, slots 17, 18, 19 and 20 are neutral. North pole depiction 372 covers the area where the spinning magnetic poles puts north pole flux into wire slots 21, 22, 23, 24, 25, 26 27 and 28. Slots 29, 30, 31 and 32 are neutral south pole depiction 373 covers the area where the spinning magnetic poles puts south pole flux into wire slots 33, 34, 35, 36, 37, 38, 39 and 40. Slots 41, 42, 43 and 44 are neutral.

FIG. 66 is a diagrammatic depiction of the internal hookup of the 3 phase 4 pole 12 coil generator of an embodiment of the invention. This hookup is referred to as a “High Wye” that is each phase has two circuits which may be connected in series and is called a “High Wye” connection which produces 480 volts or the two circuits may be in parallel as is referred to as a “Low Wye” connection and produces 240 volts but double the amperage as the “High Wye” such that the power output is the same for each hookup. We will now follow the phase circuits from the power output lead through the circuits to the neutral “Wye” connection. Phase A leg 370 is made up to coil group 389 which is wound counterclockwise (north pole) direction (in on (1) and out on (4)). The out lead 376 makes up with coil group 392 which is wound in a clockwise direction (in on (1) and out on (4)) (south pole). The out lead of these two coil groups 377 makes up with coil group 395 which is wound in a counterclockwise direction (north pole) (In on (7) and out on (10)). The out lead 378 makes up on coil group 398 wound in a clockwise direction—south pole (in on (7) and out on (10)). The out lead 379 makes up the “Wye” 384 with the other 2 phases.

Phase B leg 371 is made up to coil 391 which is wound in a counterclockwise (north pole) direction (in on (2) and out on (5)). The out lead 380 makes up with coil group 394 which is wound in a clockwise direction (south pole) (in on (2) and out on (5)). The out lead 381 makes up with coil group 397 which is wound in a counterclockwise direction (north pole) (in on (8) and out on (11)). The out lead 382 makes up with coil group 400 which is wound in a clockwise direction (south pole) (in on (8) out on (11)). Out lead 383 through lead 374 makes up a portion of “Wye” 384 connection.

Phase C leg 372 is made up to coil 393 which is wound in a counterclockwise (north pole) direction (in on (3) and out on (6)). The out lead 385 makes up with pole 396 wound in a clockwise (south pole) direction (in on (3) and out on (6)). The out lead 386 makes up with coil group 399 wound in a counterclockwise (north pole) direction (in on (9) and out on (12)). The out lead 387 makes up with coil group 390 wound in a clockwise (south pole) direction (in on (9) and out on (12)). The out lead 388 makes up with 375 which forms the third leg of the “Wye” connection 384.

With the particular spacing in the stator and this internal hookup 3 phase power with the phase legs separated electrically by 120° will be generated when a 4 pole rotor with 60° on each shoe and 30° between each shoe is employed and turned at the proper speed.

While embodiments of the invention have been described and illustrated, it will be understood by those skilled in the technology concerned that many variations or modifications in details of design or construction may be made without departing from the present invention.

1-52. (canceled)

53. An electric generator comprising:
a stator having a plurality of slots formed along a surface of the stator, each slot exposing an induction coil winding of the stator; and
a rotor assembly having a plurality of rotor members each fixedly arranged in close proximity to a respective one of the plurality of slots of the stator, each rotor member capable of rotating on an independent axis thereof, each rotor member having an armature mechanism forming magnetic poles that are activated and have magnetic polarities that, when the rotor member is rotated about the independent axis, are rotated relative to the respective one of the plurality of slots, and the rotor assembly coupled to a driver shaft for rotating the plurality of rotor members and for thereby generating an electric current.

54. The electric generator of claim 53, wherein the stator includes shielding to shield an interaction between the stator magnetic fields and the rotor magnetic fields except in an area directly between each of the rotor members and each corresponding slot of the stator.

55. The electric generator of claim 53, wherein each rotor member includes shielding to shield the interaction between the stator magnetic fields and the rotor magnetic fields the shielding having an opening to allow magnetic interactions occurring between the rotor member and the corresponding slot of the stator.

56. The electric generator of claim 53, wherein the stator comprises laminating sheets of insulation coated electrical steel.

57. The electric generator of claim 56, wherein the stator comprises one of M-15 laminated electrical steel and M-19 laminated electrical steel, having a thickness of one of 29-gauge and 26-gauge.

58. The electric generator of claim 56, wherein the shielding comprises mu metal sheets laminated with carbon steel to the surface of the stator between each wire slot as one of the components for separating the magnetic poles within the stator from the magnetic poles of the rotor.

59. The electric generator of claim 58, wherein the thickness of the mu metal sheets is in the range of 0.05 to 0.01 inches and the thickness of the laminated carbon steel is in the range of 0.03 to 0.09.

60. The electric generator of claim 53, wherein a shape of the stator includes one of a circular shape and a linear shape.

61. The electric generator of claim 53, wherein the number of slots is 48 wire slots.

62. The electric generator of claim 53, wherein the slots are located on the surface along the inner radius of the stator.

63. The electric generator of claim 53, wherein the slots are located on the surface along the outer radius of the stator.

64. The electric generator of claim 53, wherein the stator and the rotor assembly are supported by a support means in a first orientation.

65. The electric generator of claim 53, wherein the induction coils are wound into the insulated slots of the stator.

66. The electric generator of claim 65, wherein the induction coils are connected in a ordered sequence and inserted into the slots according to a pattern to allow the generation of one of single phase, two phase, and three phase electric power.

67. The electric generator of claim 53, wherein each of the plurality of rotor members spin in a designated sequence over each stator wire slot respectively, thereby reducing the interaction with the polar forces of the stator and the rotor.

68. The electric generator of claim 53, wherein the rotor members include tubular shafts supported on bearings on each of the ends of the shaft, the support provided by a support means which holds the rotors in close proximity of the stator wire slots.

69. The electric generator of claim 53, further comprising a controller for sequencing the rotation of each armature mechanism in each rotor member to turn the magnetic pole on and off.

70. The electric generator of claim 69, wherein the controller is further for sequencing the rotation of each armature mechanism such that the magnetic poles are separated by neutral nonmagnetic zones and such that fields from the magnetic poles circulate through the stator wire slots without the use of a single mechanical rotor having a single armature spinning inside or outside the stator.

71. The electric generator of claim 70, wherein the sequencing includes separating the orientation of one armature mechanism to the next armature mechanism by 15° for a two pole rotor and 7.5° for a four pole rotor when employed in a 48 wire slot stator.

72. The electric generator of claim 70, wherein the sequencing includes sequencing the rotor magnetic poles for a three phase 48 slot four pole AC generator such that in a 360° pattern eight wire slots are covered by a north pole magnetic flux, followed by four slots with no magnetic flux, followed by eight slots covered by a south pole magnetic flux, followed by four slots with no flux, followed by eight slots with north pole magnetic flux, followed by four slots with no magnetic flux, followed by eight slots covered by south pole magnetic flux, followed by four slots with no magnetic flux.

73. The electric generator of claim 70, wherein the rotor assembly further includes a master transmission coupled to the driver shaft which is driven by a drive source.

74. The electric generator of claim 70, wherein the armature mechanism includes one of a permanent magnetic powered mechanism and an electromagnetic powered mechanism.

75. The electric generator of claim 70, further comprising a feed mechanism for powering the armature mechanism, the feed mechanism including brushes and slip rings which are in sequence such that only the magnetic pole of the armature mechanism passing directly over a corresponding wire slot is electrically excited and the electrically excited magnetic pole is turned off as it completes passing directly over the wire slot to reduce interaction between magnetic fields of adjacent ones of the armature mechanisms.

76. The electric generator of claim 53, further comprising a feed mechanism for sequencing the armature mechanisms, the feed mechanism including one of a solid state mechanism and a master commutator mechanism, the feed mechanism configured to turn a magnetic pole associated with the armature mechanism on and off when the magnetic pole is disposed over a corresponding slot.

77. The electric generator of claim 53, wherein the rotor members are powered through DC batteries charged through rectifiers from one of the generator output and the power grid.

78. The electric generator of claim 53, wherein the driver includes an electric three-phase drive motor driven by a square wave variable speed controller powered through the DC batteries recharged through rectifiers from the high efficiency generator output and/or the power grid.

79. A method for generating electricity in an electric generator comprising:
forming a plurality of slots along a surface of a stator, each slot exposing an induction coil winding of the stator; and
positioning a plurality of rotor members associated with a rotor assembly, in close proximity to the plurality of slots of the stator, each rotor member positioned in fixed relation to a corresponding one of the plurality of slots, each rotor member capable of rotating on an independent axis thereof, each rotor member having an armature mechanism forming magnetic poles that are activated and have magnetic polarities that, when the rotor member is rotated about the axis, are rotated relative to the corresponding one of the plurality of slots, and the rotor assembly coupled to a driver shaft for rotating the plurality of rotor members and for thereby generating an electric current.

80. The method of claim 79, wherein the stator includes shielding to shield an interaction between the stator magnetic fields and the rotor magnetic fields except in an area directly between each of the rotor members and each corresponding slot of the stator.

81. The method of claim 79, wherein each rotor member has shielding-to shield the interaction between the stator magnetic fields and the rotor magnetic fields the shielding having an opening to allow magnetic interactions occurring at the opening of the rotor member between the opening of the rotor member and the corresponding slot of the stator.

82. The method of claim 79, wherein, the stator comprises laminating sheets of insulation coated electrical steel.

83. The method of claim 82, wherein the laminating sheets are formed from one of M-15 laminated steel and M-19 laminated steel having a thickness of one of 29-gauge and 26-gauge.

84. The method of claim 82, wherein the laminating sheets are formed from mu metal laminated with carbon steel, the laminating sheets further laminated to the surface of the stator between each wire slot for separating the magnetic poles within the stator from the magnetic poles of the rotor.

85. The method of claim 84, wherein the thickness of the mu metal sheets is in the range of 0.05 to 0.01 inches and the thickness of the laminated carbon steel is in the range of 0.03 to 0.09.

86. The method of claim 79, wherein the stator is circular.

87. The method of claim 79, wherein the number of slots is 48 wire slots.

88. The method of claim 79, wherein the surface includes a surface along an inner radius of the stator.

89. The method of claim 79, wherein surface includes a surface along an outer radius of the stator.

90. The method of claim 79, wherein the stator and rotor are supported by a support means.

91. The method of claim 79, wherein the induction coils are wound into the insulated slots of the stator.

92. The method of claim 91, wherein the induction coils are connected in a ordered sequence and inserted into the slots according to a pattern to allow the generation of one of single phase, two phase, and three phase electric power.

93. The method of claim 79, further comprising rotating the rotor members in a designated sequence over each stator wire slot, thereby reducing the interaction with the polar forces of the stator and the rotor.

94. The method of claim 79, wherein the rotor members are tubular shafts and are supported on bearings on each of the ends of the shaft, the support being contained in a support means which holds the rotors in close proximity of the stator wire slots.

95. The method of claim 79, further comprising sequencing the polarities of each armature mechanism in each rotor member to turn the magnetic pole on and off and rotate the magnetic pole of the rotor members.

96. The method of claim 79, further comprising sequencing the rotation of each armature mechanism such that the magnetic poles are separated by neutral nonmagnetic zones and such that fields from the magnetic poles circulate through the stator wire slots without the use of a single mechanical rotor having a single armature spinning inside or outside the stator.

97. The method of claim 79, wherein the sequencing includes separating the orientation of one armature mechanism to the next armature mechanism by 15° for a two pole rotor and 7.5° for a four pole rotor when employed in a 48 wire slot stator.

98. The method of claim 96, wherein the sequencing includes sequencing the rotor magnetic poles for a three phase 48 slot four pole AC generator such that in a 360° pattern eight wire slots are covered by a north pole magnetic flux, followed by four slots with no magnetic flux, followed by eight slots covered by a south pole magnetic flux, followed by four slots with no flux, followed by eight slots with north pole magnetic flux, followed by four slots with no magnetic flux, followed by eight slots covered by south pole magnetic flux, followed by four slots with no magnetic flux.

99. The method of claim 96, wherein the sequencing includes driving each of the armature mechanisms through a shaft connected to a master transmission driven by a drive source.

100. The method of claim 96, wherein the armature mechanism includes one of a permanent magnetic powered mechanism and an electromagnetic powered mechanism.

101. The method of claim 79, wherein the sequencing includes powering the mechanisms with brushes and slip rings which are energized in sequence such that only the magnetic pole of the armature mechanism passing directly over a corresponding wire slot is electrically excited and the electrically excited magnetic pole is turned off as it completes passing directly over the wire slot to reduce interaction between magnetic fields of adjacent ones of the armature mechanisms.

102. The method of claim 79, wherein the sequencing the slot rotors includes exciting and turning off the armature mechanism by using one of a solid state mechanism and a commutator mechanism.

103. The method of claim 79, further comprising powering the rotor members using DC batteries charged through rectifiers powered from one of the generator output and the power grid.

104. The method of claim 79, further comprising driving the rotor using an electric three-phase drive motor driven by a square wave variable speed controller powered through the DC batteries recharged through rectifiers from one of the high efficiency generator output and the power grid.
